(19) United States
(12) Patent Application Publication
(10) Pub. No.: US 2024/0132382 A1
(43) Pub. Date: Apr. 25, 2024

(54) FIBER-BASED MATERIALS FOR WATER TREATMENT

(71) Applicant: THE ROYAL INSTITUTION FOR THE ADVANCEMENT OF LEARNING/MCGILL UNIVERSITY, Montréal (CA)

(72) Inventors: Mathieu LAPOINTE, Warwick (CA); Nathalie TUFENKJI, Laval (CA)

(21) Appl. No.: 18/264,668

(22) PCT Filed: Feb. 4, 2022
(86) PCT No.: PCT/CA2022/050160

§ 371 Date: Aug. 8, 2023

Related U.S. Application Data
(60) Provisional application No. 63/221,978, filed on Jul. 15, 2021.
(60) Provisional application No. 63/147,289, filed on Feb. 9, 2021.

(51) Int. Cl. C02F 1/52; C02F 1/00; C02F 1/24; C02F 1/44

(52) U.S. Cl. CPC C02F 1/5272; C02F 1/004; C02F 1/24; C02F 1/44; C02F 1/5236; C02F 2001/007; C02F 2303/24; C02F 2305/12

(57) ABSTRACT

The present disclosure relates to improvements in the field of water treatment, and more particularly to the separation step in a water treatment process. There is provided a method of separating contaminants from contaminated water. A fibrous treatment agent is provided into the contaminated water. The fibrous treatment agent has a length of about 100 pm and a diameter of at least 5 pm. The fibrous treatment agent is allowed to associate with the contaminants forming floes comprising a size of at least 1000 pm. The floes are physically separated from the contaminated water.

### CROSS-REFERENCE TO RELATED APPLICATIONS

The present application claims priority from: U.S. provisional application Ser. No. 63/147,289 filed on Feb. 9, 2021 which is incorporated herein by reference in its entirety, and from U.S. provisional application Ser. No. 63/221,978 filed on Jul. 15, 2021, which is also incorporated herein by reference in its entirety.

### TECHNICAL FIELD

The present disclosure generally relates to the field of water treatment, and more particularly to the separation step in a water treatment process.

### BACKGROUND

Water treatment facilities are costly to construct and operate. Contaminant aggregation and settling of flocculated contaminants (flocs) add to these costs. Settling performance is highly dependent on the floc size and density, and requires costly, non-renewable, non-reusable (intended for landfilling), and/or toxic products; such as, metal-based coagulants (lost in sludge), and synthetic flocculants. It can also require ballast media which is an added cost, and often obtained in an unsustainable process. Indeed these currently used products often have significant environmental footprints. The floc size, that dictates contaminant removal during settling, is limited by the size of flocculant used i.e., that is less than 100 nm. The floc sizes generated with prior art technologies, do not permit floc removal through efficient screening, as flocs readily pass through coarse screens and clog smaller mesh sizes. Therefore, improvements are needed in water treatment processes particularly for separating flocs.

### SUMMARY

In one aspect there is provided a method of separating contaminants from contaminated water comprising: providing a fibrous treatment agent to the contaminated water, wherein the fibrous treatment agent has a length of at least 100 μm and a diameter of at least 5 μm; allowing the fibrous treatment agent to associate with the contaminants forming flocs comprising a size of at least 1000 μm; and physically separating the flocs from the contaminated water.

In one aspect, there is provided a method of separating contaminants from contaminated water comprising: providing the contaminated water comprising fibrous treatment agent; allowing the fibrous treatment agent to associate with the contaminants to form flocs; and physically separating the flocs from the contaminated water. In one embodiment, the fibrous treatment agent has a length of at least 100 μm and a diameter of at least 5 μm. In one embodiment, the floc has a size of at least 1000 μm.

In one embodiment, the fibrous treatment agent comprises at least one of fibers, microspheres, flakes (structures formed of at least two fibers linked together or more), hydrogels, frayed fibers, sponge materials, and other fibre based materials or porous structures.

In one embodiment, the fibers are pristine and/or functionalized.

In one embodiment, the fibrous treatment agent comprises functionalized fibers.

In one embodiment, the fibrous treatment agent comprises metal-grafted fibers or polymer-grafted fibers.

In one embodiment, the method further comprises washing and/or fragmenting the flocs to retrieve the fibrous treatment agent.

In one embodiment, a portion of the fibrous treatment agent provided includes recovered fibrous treatment agent obtained after physically separating the flocs from the contaminated water.

In one embodiment, physically separating includes one or more of sedimentation, decantation, aggregation, coagulation, flocculation, ballasted flocculation, settling, screening, sieving, adsorption, flotation, sludge blanket clarifiers, gravitational separation, and filtration.

In one embodiment, the filtration includes at least one of granular filtration, biofiltration, membrane filtration, and biosorption.

In one embodiment, the gravitational separation includes at least one of ballasted flocculation, flocculation, and flotation.

In one embodiment, the physical separation includes passing the contaminated water through a sieve, a screen, and/or a rotating drum.

In one embodiment, the fibrous treatment agent is a bridging agent, a ballasting agent, an adsorbent, a flocculant and/or a coagulation agent.

In one embodiment, the fibrous treatment agent comprises pristine fibers having a length of at least 1000 μm.

In one embodiment, the fibrous treatment agent comprises functionalized fibers.

In one embodiment, the functionalized fibers are functionalized with Si, Fe, Al, Ca, Ti, Zn (hydr)oxides, polymers, coagulants, flocculants, hydrophobic or hydrophilic entities, polar or non-polar groups, a carboxyl group, a sulfonated group, and/or a phosphoryl group.

In one embodiment, the fibrous treatment agent is iron grafted fibers.

In one embodiment, the fibrous treatment agent comprises microspheres having a diameter of at least 20 μm.

In one embodiment, the microspheres are functionalized with Si, Fe, Al, Ca, Ti, and Zn oxides and/or hydroxides, polymers, coagulants, flocculants, hydrophobic or hydrophilic entities, polar or non-polar groups, a carboxyl group, a sulfonated group, and/or a phosphoryl group.

In one embodiment, the fibrous treatment agent comprises flakes having a diameter of at least 20 μm.

In one embodiment, the flakes are functionalized with Si, Fe, Al, Ca, Ti, Zn (hydr)oxides, polymers, coagulants, flocculants, hydrophobic or hydrophilic entities, polar or non-polar groups, a carboxyl group, a sulfonated group, and/or a phosphoryl group.

In one embodiment, the fibrous treatment agent comprises fibers from municipal wastewater treatment, industrial wastewater treatment, pulp and paper industry, agriculture waste, cotton, cellulose, lignin, maize, hemicellulose, polyester, polysaccharide-based fiber, keratin, and/or recycled cellulose.

In one embodiment, the method further comprises providing a bridging agent, a ballasting agent, an adsorbent, a coagulant and/or a flocculant to the contaminated water.

In one embodiment, the flocs have a diameter of at least 1000 μm.

In one embodiment, wherein the coagulant, the adsorbent, and/or the flocculant are recovered with the fibrous treatment agent and recirculated and/or reused during aggregation or for separating the contaminants.

In one embodiment, the method is free of any coagulant and/or flocculant additions.

In one embodiment, the flocs have a diameter of at least 2000 μm.

In one embodiment, the fibrous treatment agent is already present in the contaminated water.

In one embodiment, the physically separating step is a screening step with a mesh size of at least 100 μm.

In one embodiment, the physically separating step is a screening step with a mesh size of at least 500 μm.

In one embodiment, the fibrous treatment agent is iron grafted fibers having an aspect ratio of length over diameter of at least 10.

In one embodiment, the method further comprises the step of washing and/or fragmenting the flocs to retrieve and/or reuse the fibrous treatment agent. In some cases where coagulant, flocculant, ballast media, and/or adsorbent are employed in the method, these can also be recovered and/or reused with or without the fibrous treatment agent. In one embodiment of the method, a portion of the fibrous treatment agent provided includes recovered fibrous treatment agent, coagulant, flocculant, ballast media, and/or adsorbent obtained after physically separating the flocs from the contaminated water. In one embodiment, the fibrous treatment is used as a carrier to recover and/or reuse coagulant, flocculant, ballast media, and/or adsorbent that are employed in the method as described herein.

In one embodiment, physical separation includes one or more of sedimentation, decantation, aggregation, coagulation, flocculation, ballasted flocculation, settling, screening, three dimensional screening, three dimensional porous collector, sieving, adsorption, flotation, biological treatment, sludge blanket clarifiers, gravitational separation, press filtration, belt filtration, separation via a fluidized bed, and filtration.

In one embodiment, the physical separation step is a screening step with a mesh size of at least 500 μm, preferably at least 1000 μm.

In one embodiment, the fibrous treatment agent is pristine or iron grafted fibers having an aspect ratio of length over diameter of at least 10.

In yet a further aspect, there is provided a floc having a size of at least 1000 μm and comprising pristine, metal oxide and/or hydroxide functionalized fibers, and optionally at least one of a coagulant, a flocculant, a bridging agent, an adsorbent, a ballasting agent, and a contaminant, wherein the metal oxide and/or hydroxide functionalized fibers comprise fibers selected from the group consisting of cellulose, polyester, cotton, nylon, maize, polysaccharide-based, lignin, keratin and combinations thereof. In one embodiment, the floc comprises metal oxide and/or hydroxide functionalized fibers. In one embodiment, the oxide and/or hydroxide functionalized fibers are iron oxide and/or hydroxide fibers. In one embodiment, the contaminant is selected from the group consisting of phosphorus contaminants, natural organic matter, specific natural organic matter fraction, disinfection by-products, disinfection by-products precursors, soluble contaminants, particulate contaminants, colloidal contaminants, turbidity, total suspended solids (TSS), hardness, bacteria, viruses, pathogens, microorganisms, hydrocarbons, nanoplastics, microplastics, naphthenic acids, and metals.

In one aspect, there is provided the use formulations of fibers and polymers (or other chemicals such as coagulant, flocculant, and any other chemical, media, and adsorbent used in water treatment) in the methods described herein or the flocs described herein, for biological treatment (e.g., activated sludge), or any other aggregation and separation method that don't usually required metal-based coagulant such as alum or ferric sulfate. In one embodiment, the formulations of fibers and ballast media (e.g., silica sand and magnetite) increase the floc size and density. In one embodiment, the formulation comprises fibers of different lengths (e.g. around 1000 μm cellulose fibers and >10 000 μm cotton fibers). In one embodiment, the use of formulations is for biological treatment, to improve biofilm formation and growth during biofiltration, activated sludge system, or any other biological treatment. In one embodiment, the use of the formulation is for the treatment of domestic wastewater or other decentralized treatment applications. In one embodiment, the formulations further comprise granular media (such as sand, anthracite, granular activated carbon). In one embodiment, the use comprises a porous collector, for filtration applications.

Many further features and combinations thereof concerning the present improvements will appear to those skilled in the art following a reading of the instant disclosure. As would be understood by those skilled in the art, the aspects described herein may be combined with any of the embodiments described herein. Furthermore, the embodiments can also be combined with one or more other embodiments described herein.

### DESCRIPTION OF THE DRAWINGS

FIG. 1A is a schematic flow diagram of a separation method according to the prior art;

FIG. 1B is a schematic flow diagram of a separation method according to one embodiment of the present disclosure;

FIG. 2A is a schematic representation of a floc according to the prior art.

FIG. 2B is a schematic representation of a floc formed with pristine fibers according to an embodiment of the present disclosure.

FIG. 2C is a schematic representation of a floc formed with functionalized fibers according to an embodiment of the present disclosure.

FIG. 2D is a schematic representation of a floc formed with a flake according to an embodiment of the present disclosure.

FIG. 2E is a graph of the screened (left bar graph) and settled turbidity (right bar graph) for each of a no fibers condition (negative control), pristine fibers according to an embodiment of the present disclosure, nanofibers having a length of less than 200 nm, microfibers having a length of less than 10 μm, and microfibers having a length of 10-100 μm.

FIG. 2F is a microscopy image an example of conventional flocs (prior art, left) formed, compared to flocs formed with fibers according to an embodiment of the present disclosure (center) and flocs formed with microspheres according to an embodiment of the present disclosure (right) with a zoom-in schematic representation. Scale bar is 1000 μm.

FIG. 2G is a microscopy image of flocs formed with flakes according to an embodiment of the present disclosure having a size that can be trapped in a 1000 μm mesh screen (left), 2000 μm mesh screen (center) and 3000 μm mesh screen (right) with a zoom-in schematic representation. Scale bar is 1000 μm.

FIG. 3A is a schematic comparison of pristine fibers and of synthesized SiO₂-fibers of one embodiment of the present disclosure, as well as a characterization of SiO₂-fibers. Graphs of scanning electron microscopy-energy dispersive spectroscopy (SEM-EDS) and Fourier transform infrared spectroscopy (FTIR) are shown and demonstrate that the presence of grafted SiO₂ is confirmed;

FIG. 3B is a graph of settled turbidity vs settling time illustrating the impact of pristine fiber (∘), SiO₂-fibers (▪), and SiO₂-microspheres (▴) vs. conventional treatment (no fiber) (● top most curve) on turbidity removal rates. Error bars indicate standard deviation obtained from duplicate experiments;

FIG. 3C is a graph of settled turbidity vs settling cycles illustrating the impact of repeated cycles on turbidity removal for SiO₂-fibers (▴), and SiO₂-microspheres (▪), where the dashed line shows the industry standard after treatment (1 NTU);

FIG. 3D is a graph of mass change vs temperature illustrating a determination of grafted SiO₂ content on acid-washed fibers extracted from wastewater using thermogravimetric analysis (TGA);

FIG. 3E is a graph of settled turbidity vs coagulant concentration illustrating the impact of a fibrous treatment agent (100 mg fibers/L (▴), 100 mg SiO₂-fibers/L (▪), and 1000 mg SiO₂-microspheres (♦)) of embodiments of the present disclosure vs. conventional prior art treatment (no fibers) (●) on an known coagulant (e.g., alum) concentration. Reductions in coagulant demand of ˜20% and ˜40% with fibers (pristine or SiO₂-fibers) and SiO₂-microspheres, respectively, maintained a settled turbidity of 1 NTU after 1 min settling. Conditions: 30 mg of coagulant/L (e.g., alum), 0.25 mg flocculant/L (e.g., polyacrylamide), where the dashed line indicates the industry standard after treatment (1 NTU). Error bars indicate standard deviation obtained from duplicate experiments;

FIG. 3F is a graph of settled turbidity vs flocculant concentration illustrating the impact of SiO₂-fibers on the required flocculant (e.g., polyacrylamide) concentration. Reductions in flocculant demand of ˜40% and more than 60% after 15 s and 1 min of settling, respectively, when 50 mg SiO₂-fibers/L was used to achieve a settled turbidity of 1 NTU. Conditions: 30 mg of coagulant/L (e.g., alum). The dashed line indicates the industry standard after treatment (1 NTU). 15 s of settling with no fibers (♦), 15 s of settling with 50 mg SiO₂-fibers/L (▴), 1 min of settling with no fibers (●), and 1 min of settling with 50 mg SiO₂-fibers/L (▪). Error bars indicate standard deviation obtained from duplicate experiments;

FIG. 4A is a schematic representation of floc formation and trapping via screening according to one embodiment of the present disclosure. Conventional prior art flocs are not removed (middle) while flocs formed with different types of fibers or SiO₂-microspheres according to one embodiment of the present disclosure (top and bottom) are easily trapped;

FIG. 4B is a graph of screened turbidity vs screen size illustrating an impact of screen mesh size and type of fibers/microspheres on screened water turbidity. Horizontal dashed line shows the industry standard after treatment (1 NTU). No fibers conventional treatment (-), cellulosic fibers (▴), recycled cellulosic fibers (Δ), polyester fibers ( [symbol] ), keratin fibers (∘), cotton fibers (⋄), and SiO₂-microspheres (▪);

FIG. 4C is a graph of screened turbidity vs screen size illustrating an impact of screen mesh size and type of fibers/microspheres on screened water turbidity. Horizontal dashed line shows the industry standard after treatment (1 NTU). Cellulosic fibers (▴) and SiO₂-microspheres (▪);

FIG. 5A is a schematic of a flake synthesis according to one embodiment of the present disclosure, the figure illustrates natural organic matter (NOM) adsorption on cationic (hydr)oxide patches (before coagulant and flocculant injection), floc and colloid aggregation on flakes, and NOM and colloids-loaded flakes trapped on a screen (or other separation methods);

FIG. 5B shows a graph of NOM (surface water) adsorption and removal as function of flake concentration. Dashed line indicates the average result obtained from duplicates;

FIG. 5C shows a graph of soluble phosphorus adsorption and removal in contaminated water as a function of flake concentration. Dashed line indicates the average result obtained from duplicates;

FIG. 5D shows the composition of flakes and stuffed flakes determined by TGA.

Stuffed flakes were filled with recycled crushed glass (density of 2.6) to increase the material density;

FIG. 6A is a photograph of two containers containing flocs in water according to the prior art (top container) and according to the present disclosure (bottom container), the scale is in cm;

FIG. 6B is a graph of the screened turbidity as a function of the mesh size for a screening according to the present disclosure. Iron grafted fibers (∘) were used (Alum: 30 mg/L. Polyacrylamide: 0.3 mg/L) and a treatment according to the prior art (▴);

FIG. 7A is a graph of the screened turbidity as a function of the cycle number after a screening with a 500 μm screen, Fe-grafted fibers were used in combination with alum, namely 30 mg/L alum (cycle 1) and no extra alum (cycles 2-4) (100 mg/L fibers) (●); 10 mg/L alum (no fibers) (⋄); 10 mg/L alum (100 mg/L fibers) (X); 30 mg/L alum (no fibers) (□); and 30 mg/L alum (cycle 1) and +10 mg/L alum (cycles 2-4) (100 mg/L fibers) (∘);

FIG. 7B is a graph of the screened turbidity as a function of the cycle number after 3 min of settling, Fe-grafted fibers were used in combination with alum, namely 30 mg/L alum (cycle 1) and no extra alum (cycles 2-4) (100 mg/L fibers) (●); 10 mg/L alum (no fibers) (0); 10 mg/L alum (100 mg/L fibers) (X); 30 mg/L alum (no fibers) (□); and 30 mg/L alum (cycle 1) and +10 mg/L alum (cycles 2-4) (100 mg/L fibers) (∘);

FIG. 7C is a scanning electron microscopy (SEM) image of the functionalized fibers associated with flocs;

FIG. 7D is a scanning electron microscopy—energy dispersive spectroscopy (SEM-EDS) image showing coagulant (alum detected by measurement of Al) attached to the functionalized fiber. Light areas represent detected Al;

FIG. 8A is a graph showing the concentration of natural organic matter (NOM) contaminants as a function of the concentration of Fe-grafted fibers according to the present disclosure (raw water: 4.6 mg C/L, pH: 7.0±0.2 with 30 mg alum/L) (the dashed line represents average values obtained from replicates);

FIG. 8B is a graph showing the concentration of soluble phosphorus contaminant when Fe-grafted fibers according to the present disclosure are used as an adsorbent without a coagulant (the dashed line represents average values obtained from replicates; open symbols are the replicates of closed symbols);

FIG. 8C is a graph showing the phosphorus reduction as a function of alum dose for a treatment with 200 mg/L iron grafted fibers according to the present disclosure (A) and without fibers (□);

FIG. 9 shows the composition of Fe-grafted fibers (full line) vs. pristine fibers (dashed line) determined by TGA;

FIG. 10 is a graph of the iron removal as a function of the flakes concentration after adsorption;

FIG. 11A is a graph of the extracellular polymeric substances (EPS) deposition rate measured using a quartz crystal microbalance (QCM) (at pH 7);

FIG. 11B is a graph of proteins and humics deposition rates (deposition on SiO₂ versus Fe 2 O 3 surfaces) measured by quartz-crystal microbalance (QCM) at pH 7;

FIGS. 12A-12C are graphs of the impact of iron concentration (12A), of polyacrylamide concentration (12B) and of pH (12C) during fibrous materials synthesis on the iron surface coverage (obtained by XPS);

FIG. 13 is a graph of the impact of Fe-grafted fibers and pristine fibers on the removal of emerging contaminants e.g., hydrocarbons (BTEX: benzene, toluene, ethybenzene, p-, m-xylene, and o-xylene). No coagulant and no flocculant. 200 mg fibers/L, pH 7.6, mixed during 10 min;

FIG. 14A is a graph of the impact of screen mesh size on the turbidity removal for wastewater application (wastewater turbidity: 56 NTU, pH: 7.8±0.3; conditions: 60 mg alum/L, 0.4 mg flocculant/L and 200 mg fibers/L). Dashed lines represent the average value obtained from triplicates for no fibers (●) and 200 mg/L fibers (▴);

FIG. 14B is a graph of the impact of screen mesh size on nanoplastic removal for wastewater application (wastewater turbidity: 56 NTU, pH: 7.8±0.3; conditions: 60 mg alum/L, 0.4 mg flocculant/L and 200 mg fibers/L). Dashed lines represent the average value obtained from triplicates for no fibers (●) and 200 mg/L fibers (Δ);

FIG. 14C is a graph of the impact of settling time on nanoplastic removal for wastewater application (wastewater turbidity: 56 NTU, pH: 7.8±0.3; conditions: 60 mg alum/L, 0.4 mg flocculant/L, 200 mg fibers/L) for Fe-fibers (▴) and pristine fibers (Δ);

FIG. 14D is a graph of the impact of fiber concentration on microplastic removal for wastewater application (wastewater turbidity: 56 NTU, pH: 7.8±0.3; conditions: 60 mg alum/L, 0.4 mg flocculant/L, 200 mg fibers/L and 3 min of settling);

FIG. 15A shows the impact of fiber reusability over 5 cycles on the turbidity removal (wastewater turbidity: 56 NTU, pH: 7.8±0.3; conditions: 60 mg alum/L, 0.4 mg flocculant/L, 200 mg fibers/L and 3 min of settling). Dashed line represents the average value obtained from triplicates;

FIG. 15B is a graph of the impact of pH during the washing of fibers. Settled fibers were rinsed at pH 7 and 10. Error bars represent the standard deviation obtained from triplicates;

FIG. 16 a graph showing the elemental characterization by XPS of pristine and Fe-fibers, before and after usage (wastewater turbidity: 56 NTU, pH: 7.8±0.3; conditions: 60 mg alum/L, 0.4 mg flocculant/L, 200 mg fibers/L and 3 min of settling). The coagulant alum and the flocculant (polyacrylamide) were still attached on fibers after usage;

FIG. 17 is a graph showing the settled turbidity as function of the cationic polymer concentration (e.g., polyacrylamide or quaternary amine-based polymers) (wastewater turbidity: 56 NTU, pH: 7.8±0.3; conditions: no coagulant (alum), 200 mg pristine fibers/L and 3 min of settling). [symbol] : 8 min of aggregation, ▴: 2 min of aggregation. Dashed line represents the average value obtained from triplicates;

FIG. 18 is a graph showing the screened turbidity as function of the cationic polymer concentration (e.g., polyacrylamide or quaternary amine-based polymers) (water turbidity: 6 NTU, pH: 7.7±0.3; conditions: no coagulant (alum), 200 mg pristine fibers/L, flocs suspension was screened via a press filter system with screen mesh size of 500 μm; no settling was required);

FIG. 19 is a graph showing the settled turbidity as function of the cationic polymer concentration (e.g., polyacrylamide or quaternary amine-based polymers) when a ballast media (4 SiO₂ g/L, d50=130 μm) is used alone or in combination with fibers (wastewater turbidity: 56 NTU, pH: 7.8±0.3; conditions: no coagulant (alum), 200 mg pristine fibers/L, aggregation during 2 min, and 3 min of settling). Error bars represent the standard deviation obtained from triplicates;

FIG. 20 is a graph that shows the screened turbidity as function of the screen mesh size when cellulose fibers (average length˜1000 μm, 200 mg fibers/L) are used alone, or in combination with longer fibers (cotton, average length>10,000 μm, 1000 mg fibers/L) (wastewater turbidity: 56 NTU, pH: 7.8±0.3; conditions: no coagulant (alum), 2 mg cationic polymers/L, aggregation during 20 sec, no settling is required). Dashed lines represent the average value obtained from triplicates;

FIG. 21 shows the removal of naphthenic acids by adsorption on pristine fibers and Fe-grafted fibers at pH 6 and 7. Wastewater: 100 mg/L naphthenic acids. Fiber concentration: 1000 mg/L (no coagulant and no flocculant). Fibers were removed from treated waters via a 20 μm screen mesh; and

FIG. 22 shows the removal of turbidity via screening (1000 μm screen mesh). Conventional treatment (∘) is compared to fibrous treatment (pristine fibers (▴)) with different alum concentration. Domestic wastewater: pH 7.3, turbidity of 181 NTU. Flocculant: 1 mg polyacrylamide/L.

### DETAILED DESCRIPTION

The present disclosure concerns the treatment of water containing contaminants using a physical separation. The contaminants can be natural organic matter (NOM), specific NOM fractions, phosphorus and other soluble contaminants as well as particulate or colloidal contaminants (such as turbidity and total suspended solids (TSS)). The water provided to the present methods for treatment, in some embodiments, can be raw or pre-treated, to remove the macro and large contaminants (cellulose, polyester, cotton, nylon, keratin and the like). The term “physical separation” as used herein refers to a separation that relies on at least one physical characteristic such as the size and/or density of contaminant species to remove them from the contaminated water. In one embodiment, the physical separation is one or more of sedimentation, decantation, aggregation, settling, screening, sieving, adsorption, gravitational separation, flotation, sludge blanket clarifier, and filtration. For example, the filtration is at least one of granular filtration, membrane filtration, biofiltration, and biosorption. In another example, the gravitational separation is at least one of ballasted flocculation, flocculation, and air-dissolved flotation.

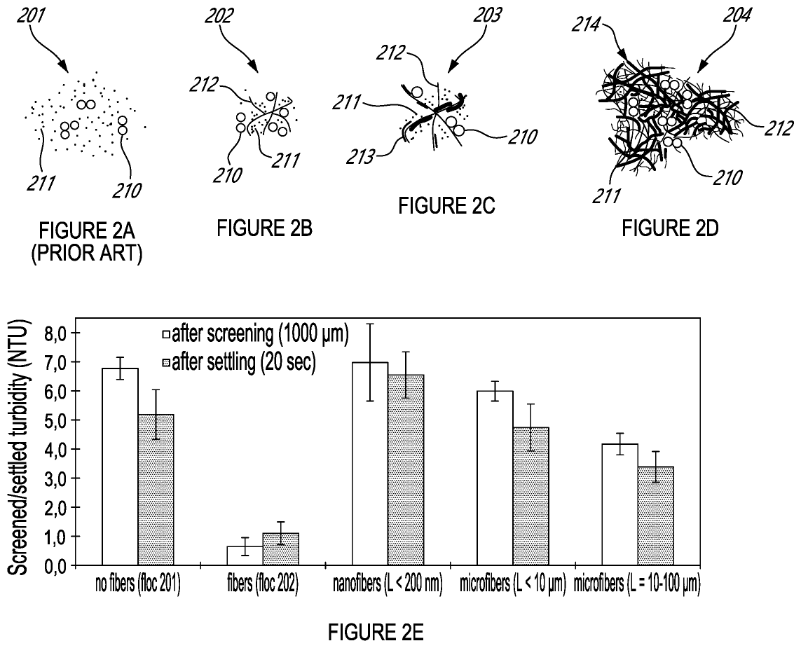

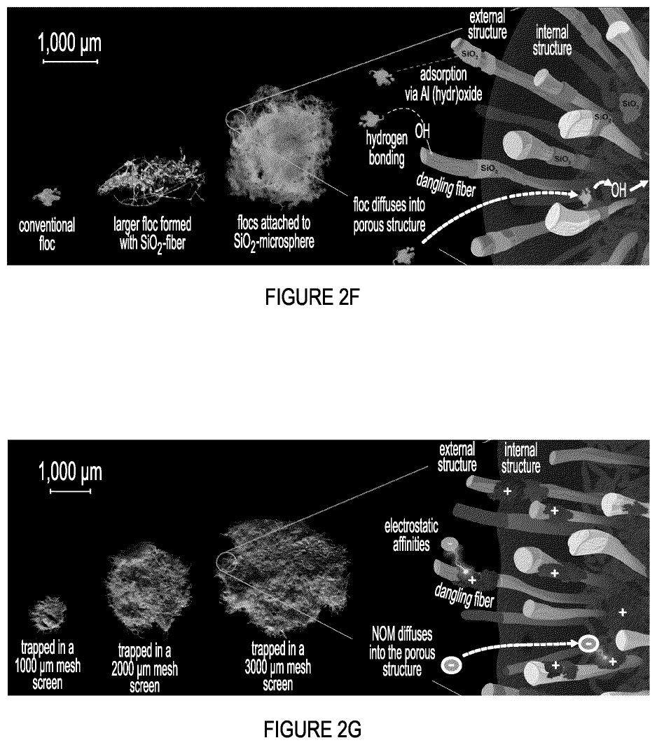

To achieve adequate physical separation and simultaneously achieve improved sustainability, cost and efficiency, fibrous treatment agents having a length of at least 100 μm and a diameter of at least 5 μm are used. The fibrous agents could be already present in the water to be treated (e.g., domestic wastewater that contains textile fibers, or wastewater from the pulp & paper industry containing cellulose/lignin fibers), or added to the water to improve treatment. These fibrous treatment agents can be engineered from fibers recovered from wastes from wastewater treatment plants, pulp and paper industry and from other industries; namely, cotton, cellulose, polyester, and keratin fibers, and other waste, recycled and pristine materials. The fibrous treatment agents, such as fibers, microspheres (FIG. 2F), flakes (FIG. 2G), aggregates, hydrogels, sponge materials and fiber-based materials can be assembled as pristine or functionalized with oxides, hydroxides, metal oxides, metal hydroxides, hydrophobic or hydrophilic entities, polar and nonpolar groups, metallic elements and/or polymers. More specifically, the fibrous treatment agent can contain pristine and/or functionalized fibers/microspheres/flakes. The fibrous treatment agents of the present disclosure include fibers that are functionalized with oxides, hydroxides, metal oxides, metal hydroxides, hydrophobic or hydrophilic entities, polar and nonpolar groups, metallic elements and/or polymers. The fibrous treatment agents of the present disclosure also include fibers that are chemically modified e.g., with (quaternary) amines, coagulant, flocculant, with hydrophobic or hydrophilic entities, with polar and nonpolar groups or carboxylated, sulfonated and/or phosphorylated fibers. In a preferred embodiment, the fibrous treatment agent is a fiber grafted with iron oxides and/or hydroxides. Prior to functionalization, the fiber can be pristine fiber. The term “pristine fibers” as used herein refers to fibers that are free of any functionalization or chemical modification. The term pristine can refer to fibers recovered from waste such as keratin-based fibers or maize residues as long as they were not functionalized after the recovery from the waste. The fibrous treatment agents can be tuned in terms of size, density, surface area, and surface chemistry to be optimal to the specific type of contamination that needs to be treated. The use of the fibrous treatment agents of the present disclosure drastically improves contaminant removal during water treatment (such as settling) by increasing the size and/or density of flocs. The fibrous treatment agents have at least one of the following functions: coagulating, flocculating, bridging, ballasting, and adsorbing. Moreover, in some embodiments the fibrous treatment agents can have all of these functions which can be particularly advantageous in reducing the requirements of other chemicals and thereby reducing the cost of the operation as well as the environmental footprint. The fibrous treatment agents described herein allow for the production of flocs that have a size that is screenable and/or has an improved settling speed. In prior art water treatment methods the settling tank is essential to completely remove the flocs. However, a wastewater treatment using the present fibrous treatment agent may optionally eliminate the step of the settling tank. The settling tank is a costly process unit with limited sustainability. Thus, the present methods reduce the cost and improve the sustainability of water treatment.

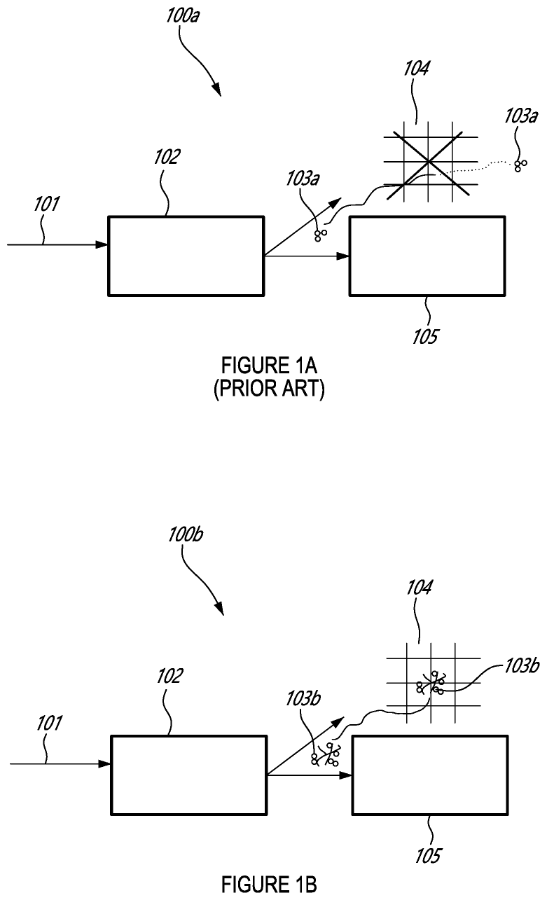

Referring to FIGS. 1A and 1B, a process according to the prior art 100a and according to the present disclosure 100b, has raw water 101 that requires treatment, provided to an aggregation tank 102. In FIG. 1A, the floc 103a produced is too small (usually less than 500 μm) to be captured by screening 104. Therefore, it is not possible to capture the flocs using screening 104 according to the prior art. However, the flocs can be separated by settling (settling tank 105). Unfortunately, prior art methods of settling require improvements as they are too time consuming and costly. In contrast, as illustrated in FIG. 1B, the flocs 103b produced according to the present disclosure are of a larger size (e.g. about 1000 μm or larger) and can be captured by screening 104. Therefore, according to one embodiment of the present disclosure it is possible to choose to only perform screening 104 and eliminate the need for the settling tank 105. This would significantly reduce the operating time, costs and efficiency. However, the settling tank 105 can also be used in addition or instead of the screening 104. In that case, the larger flocs of the present disclosure would settle faster than the smaller flocs according to the prior art. Thus, a settling step according to the present disclosure method is faster, more efficient and more cost effective when compared to the prior art settling.

Different exemplary flocs are illustrated in FIG. 2A-2D. A prior art floc 201 has a small size and consists of aggregated contaminants with coagulants and flocculants 210. The size of prior art flocs is generally <500 μm. Some of the natural organic materials (NOM) and some other soluble or colloidal contaminants 211 are not associated with the prior art floc as illustrated in the figure. In contrast, the flocs 202, 203, and 204 according to the present disclosure associate with more of the contaminants. The word “associated” as used herein, means that contaminants (e.g., natural organic materials (NOM) and other soluble or colloidal contaminants 211) are part of the floc, they can be entrapped without any chemical binding and/or they can bind to parts of the flocs (intermolecular bonds such as hydrogen bonds, electrostatic interactions, and/or dipole-dipole, and/or intramolecular bonds such as ionic bonds and/or covalent bonds). The flocs according to the present disclosure can capture contaminants including but not limited to particulates, turbidity, NOM, phosphorus, total suspended solids (or any other types of soluble molecules, colloids or contaminants), nanoplastics, microplastics, hydrocarbons (e.g., BTEX) or other contaminants issued from the petrochemical industry (e.g., naphthenic acids), nanoplastics, microplastics, heavy metals, arsenic (issued from mining, pulp and paper, agriculture wastewater/drainage water, food industry, petrochemical, or other industries, or in domestic or other decentralized treatment applications). A floc 202 produced with pristine fibers according to an embodiment of the present disclosure can reach the size of at least 1000 μm and includes the coagulants and flocculants 210, the NOM and soluble/colloidal contaminants 211 as well as fibers 212. A floc 203 produced with functionalized fibers according to one embodiment of the present disclosure also reaches the size of at least 1000 μm and includes the coagulants and flocculants 210, the NOM and soluble/colloidal contaminants 211, fibers 212 having functionalized groups or coating 213 at their surface. Moreover, a floc 204 produced from a flake 214 that has fibers 212 that are functionalized according to one embodiment of the present disclosure, captures the soluble (NOM and P) and particulate/colloidal contaminants 211 and includes the coagulants and flocculants 210. Notably, the flocs according to the present disclosure have an increased density which increases the settling speed of the flocs. The fibrous treatment agents of the present disclosure can simultaneously adsorb natural organic matter (NOM), specific NOM fraction, and phosphorus (or other soluble contaminants), bridge colloids together, effectively ballast flocs and reduce chemical usage (e.g., coagulants and flocculants). The flocs produced are screenable, which allows optionally eliminating the settling tank, a costly and high footprint process unit. This process improvement is only possible if fibers are long enough as disclosed herein or if microspheres/flakes are used. Contrary to pristine fibers or functionalized fibers (flocs 202 and 203), nanofibers and microfibers do not improve the size of floc, nor their removal during settling or screening (FIG. 2E).

As used herein the term “coagulant” refers to an agent that promotes the destabilization of a colloidal suspension and/or precipitates soluble contaminants. The coagulant can for example, neutralize the electrical charge on colloidal particles, which destabilizes the forces keeping the colloids apart. As used herein the term “flocculant” refers to an agent that promotes flocculation by increasing floc size and/or stabilizing the floc shape. For example, the flocculant can cause colloids or other suspended particles to aggregate and form a floc. Typically, a flocculant is used to increase the size of flocs, notably by aggregating the particles formed during coagulation. As used herein the terms “ballasting”, “ballasting agent” or “ballast media” refers to an agent that increases the size and/or the density of flocs. As used herein the term “adsorbent” refers to an agent that absorbs contaminants and thereby captures the contaminants within its fibrous matrix or on its surface. As used herein the term “bridging agent” refers to an agent or linear structure able to connect particles or flocs together, hence increasing the size of flocs. For example, fibers having a length larger than 100 μm are considered bridging agents.

To produce the flocs, a fibrous treatment agent comprising fibers in the form of free fibers can be used. In one example the free fibers are functionalized. In another example the free fibers are pristine. In a further example, the free fibers can be a mix of functionalized and pristine. In one embodiment, the fibrous treatment agent comprises pristine fibers having a length of at least 10 μm, at least about 100 μm, at least about 500 μm, at least about 1000 μm, at least about 2000 μm, at least about 3000 μm, at least about 4000 μm, or at least about 5000 μm, and a diameter of at least about 5 μm, at least about 6 μm, at least about 7 μm, at least about 8 μm, at least about 9 μm, at least about 10 μm, at least about 15 μm, at least about 20 μm, or at least about 50 μm. For example, the pristine fibers can have a length of between about 100 to about 15,000 μm, about 1000 to about 15,000 μm, about 2000 to about 15,000 μm, about 3000 to about 15,000 μm, about 4000 to about 15,000 μm, or about 5000 to about 15,000 μm. In one embodiment, the pristine fibers have an aspect ratio of length over diameter of at least about 10, at least about 15, at least about 20, or at least about 25. The density of the fibers depends on the type of fibers used during its synthesis (e.g., cellulose, cotton, polyester, keratin, nylon, etc. which can be pristine, waste or recycled). For example, the density of fibers that are not functionalized is between about 0.6 to about 1.5. In one embodiment, the fibrous treatment agent consists of pristine fibers as defined herein. In a further embodiment, the fibrous treatment comprising or consisting of pristine fibers is free of functionalized fibers. Pristine fibers according to the present disclosure are particularly suitable for use as super bridging agents. The effectiveness of pristine fibers as super bridging agents increases with size, for example a length of at least 1000 μm. The fibers used to obtain the pristine fibers of the fibrous treatment agent may be cellulosic fibers derived from wastewater fibers (such as bathroom tissue), and/or recycled cellulosic fibers (such as from blended domestic residues or pulp and paper industry wastes).

In one embodiment, the fibrous treatment agent comprises functionalized fibers. In one embodiment, the fibrous treatment agent comprises functionalized fibers having a length of at least about 100 μm, at least about 150 μm, at least about 200 μm, at least about 300 μm, at least about 400 μm, at least about 500 μm, at least about 1000 μm, or at least about 2000 μm, and a diameter of at least about 5 μm, at least about 6 μm, at least about 7 μm, at least about 8 μm, at least about 9 μm, at least about 10 μm, at least about 15 μm, at least about 20 μm, or at least about 50 μm. For example, the functionalized fibers can have a length of between about 100 to about 15,000 μm, about 200 to about 15,000 μm, about 300 to about 15,000 μm, about 400 to about 15,000 μm, about 500 to about 15,000 μm, about 1000 to about 15,000 μm, or about 2000 to about 15,000 μm. In one embodiment, the functionalized fibers have an aspect ratio of length over diameter of at least about 10, at least about 15, at least about 20, or at least about 25. The density of the fibers depends on the functionalization and on the type of fibers used during its synthesis (e.g., cellulose, cotton, polyester, keratin, nylon, etc. which can be pristine, waste or recycled). The density increases with increasing levels of functionalization. In one embodiment, the density is at least about 1.5. The term “functionalized” as used herein refers to a functionalization with metal ions, metal oxides and other hydroxides such as Si, Ca, Ti, Zn, Al and/or Fe oxides and hydroxides (monomeric or polymeric forms), and/or with organic polymers such as polyamines, polyacrylamides, polydiallyldimethylammonium chloride, epichlorohydrin/dimethylamine, polysaccharide-based polymers, and any other polymers with hydrophobic or hydrophilic entities, coagulants, flocculants, and/or fiber binding/linking agents. The functionalization grants the fibers increased interactions with contaminants. Functionalized fibers are particularly suitable to be used as a bridging agent, adsorbent and/or ballasting agent. In one embodiment, the surface area is estimated to be about 10 to 300 m²/g, 10 to 350 m²/g, 10 to 400 m²/g, or 10 to 500 m²/g. The fibers may be cellulosic fibers derived from wastewater fibers (such as bathroom tissue), and/or recycled cellulosic fibers (such as from blended domestic residues or pulp and paper industry wastes). Although more costly, it is also an option to produce the fibers from pristine cellulosic fibers. The use of fibers in the treatment agent allows for a reduction in the amounts of coagulant and flocculant needed, increases the floc settling velocity, and produces flocs that can be extracted by screening.

The fibrous treatment agent can include microspheres (FIG. 2F) in addition or instead of fibers to produce the improved flocs having increased size and density. Microspheres can surpass the performance of free fibers during water treatment by forming larger and denser flocs which lead to better removal during settling and screening. In one embodiment, the microsphere has a diameter of at least about 20 μm, at least about 50 μm, at least about 100 μm, at least about 200 μm, at least about 500 μm, at least about 1000 μm, at least about 1500 μm, at least about 2000 μm, at least about 3000 μm, at least about 4000 μm, at least about 5000 μm, at least about 10,000 μm, at least about 15,000 μm, or at least about 20,000 μm. For example, the microspheres can have a diameter of between about 20 μm to about 50,000 μm, about 50 μm to about 50,000 μm, about 100 μm to about 50,000 μm, about 200 μm to about 50,000 μm, about 500 μm to about 50,000 μm, about 1000 μm to about 50,000 μm, about 1500 μm to about 50,000 μm, about 2000 μm to about 50,000 μm, about 3000 μm to about 50,000 μm, about 4000 μm to about 50,000 μm, about 5000 μm to about 50,000 μm, about 10,000 μm to about 50,000 μm, about 15,000 μm to about 50,000 μm, or about 20,000 μm to about 50,000 μm. Microspheres are functionalized and can be produced from functionalized precursor fibers. The density of the microspheres depends on the functionalization. For example, the density of microspheres that are not heavily functionalized is between about 0.6 to about 1.5. The density increases with increasing levels of functionalization. In one embodiment, the density is at least about 1.5.

The fibrous treatment agent can include flakes (FIG. 2G) in addition or instead of fibers and microspheres to produce the improved flocs having increased size and density. Similarly to microspheres, can surpass the performance of free fibers during water treatment by forming larger and denser flocs which lead to better removal during settling and screening. In one embodiment, the flake has a diameter of at least about 20 μm, at least about 50 μm, at least about 100 μm, at least about 200 μm, at least about 500 μm, at least about 1000 μm, at least about 1500 μm, at least about 2000 μm, at least about 3000 μm, at least about 4000 μm, at least about 5000 μm, at least about 10,000 μm, at least about 15,000 μm, or at least about 20,000 μm. For example, the flakes can have a diameter of between about 20 μm to about 50,000 μm, about 50 μm to about 50,000 μm, about 100 μm to about 50,000 μm, about 200 μm to about 50,000 μm, about 500 μm to about 50,000 μm, about 1000 μm to about 50,000 μm, about 1500 μm to about 50,000 μm, about 2000 μm to about 50,000 μm, about 3000 μm to about 50,000 μm, about 4000 μm to about 50,000 μm, about 5000 μm to about 50,000 μm, about 10,000 μm to about 50,000 μm, about 15,000 μm to about 50,000 μm, or about 20,000 μm to about 50,000 μm. Flakes are functionalized and can be produced from functionalized precursor fibers. The density of the flake depends on the functionalization and on the type of fibers (e.g., cellulose, cotton, polyester, keratin, nylon, etc. that can be pristine, waste or recycled) used during its synthesis. For example, the density of microspheres that are not heavily functionalized is between about 0.6 to about 1.5. The density increases with increasing levels of functionalization. In one embodiment the density is at least about 1.5.

In some embodiments, the fibrous treatment agent consists of functionalized fibrous components. In other embodiments, the fibrous treatment agent comprises or consists of functionalized fibrous components and is free of pristine fibers. In one example, the fibrous components comprise functionalized free fibers, microspheres and/or flakes. In one embodiment, the fibrous treatment agent is functionalized with amines (e.g. quaternary), coagulant, flocculant, with hydrophobic or hydrophilic entities, polar and/or non-polar groups, a carboxymethylation, a sulfonation and/or a phosphorylation. Functionalization can be performed as the agent is produced or subsequently. Functionalization can improve the removal of negatively and positively charged contaminants during water treatment (e.g., negatively charged nanoplastics). In one embodiment, to graft, functionalize or link fibers together, or to synthesize grafted fibers or fiber-based aggregates, oxides and hydroxides such as Al(OH)ₓ, Fe(OH)ₓ, Al₂O₃, Fe₂O₃, CaCO₃, Fe₃O₄, FeOOH, SiO₂, TiO₂ and ZnO and any other monomeric or polymeric hydroxides or oxides can be used (alone or as a blend). Furthermore, in one embodiment, inorganic and organic (e.g. cationic) polymers such as polyamines (e.g. functionalized with quaternary amine group), polyacrylamides, polydiallyldimethylammonium chloride, epichlorohydrin/dimethylamine, polysaccharide-based polymers, and any other polymers with hydrophobic or hydrophilic entities, and/or fiber binding/linking agents can be used. To increase the mechanical resistance of the fibrous treatment agent, it can be reinforced 1) by adding high molecular weight polymers during synthesis promoting internal linkages or 2) by grafting Si (or other hydroxides or oxides) on the external structure of the materials. In one example, the concentration of Fe grafted on fibers of the fibrous treatment agent is about 0 or about more than 0, to about 90 w/w %, or higher (near 100). Similarly, in one example, the concentration of Si grafted on fibers of the fibrous treatment agent is about 0 or about more than 0, to about 90 w/w % or higher (near 100).

The following table presents exemplary components or precursor materials of the fibrous treatment agent.

TABLE 1
Examples of fibrous treatment agent
components and precursor materials.

| | Fiber/material | Fiber/material |
|---|---|---|
| Type of fibers/materials | length (μm) | diameter (μm) |
| Cellulosic fibers | 100-50 000 μm, or | 2-2000 μm, or |
| | more | more |
| Polyester, cotton, lignin, | 0.05-50 000 μm, or | 0.05-2000 μm, or |
| polysaccharides-based, | more | more |
| keratin, maize, nylon, fibers, | | |
| or other types of fibers such | | |
| as pristine, recycled or | | |
| reused fibers from textile, | | |
| pulp and paper, and food | | |
| industries, or other industries. | | |
| Functionalized fibers (e.g., | 0.05-50 000 μm, or | 0.05-2000 μm, or |
| carboxylated, sulfonated, | more | more |
| phosphorylated) | | |
| Fibers grafted with | 0.05-50 000 μm, or | 0.05-2000 μm, or |
| (hydr)oxides | more | more |
| Fibers modified with | 0.05-50 000 μm, or | 0.05-2000 μm, or |
| polymers | more | more |
| Fibrous treatment | — | 20-50 000 μm, or |
| (microsphere) | | more |
| Fibrous treatment (flake) | — | 20-50 000 μm, or |
| | | more |

Accordingly there is provided a method of treating water with the fibrous treatment agents of the present disclosure described above (pristine fiber, functionalized fiber, microsphere, and/or flake). The water suitable to be treated in the present methods includes “raw” water or previously treated water, for example to remove macro and large contaminants. Raw water can refer to water directly extracted from a natural body of water (river, lake, sea, ocean, ground water, etc.), or output water from an industrial plant (e.g., municipal wastewaters and sludge, steel and aluminum industries, food processing, pulp and paper, agriculture wastewaters/drainage water, pharmaceutical, mining, and petrochemical) or a tailings pond (naphthenic acids) or domestic wastewater or other decentralized treatment applications. The water may be treated before the present fibrous treatment agent is added to the water. Such treatments include but are not limited to removing at least a portion of the macro and large contaminants. The fibrous treatment can be implemented at the influent of the water treatment plant (e.g., before coagulation), in the coagulation tank, or injected later in the process (e.g., in the flocculation tank, in settling tank or during filtration). The fibrous treatment can also be used at the effluent of the plant, to treat, dewater and/or dehydrate sludge.

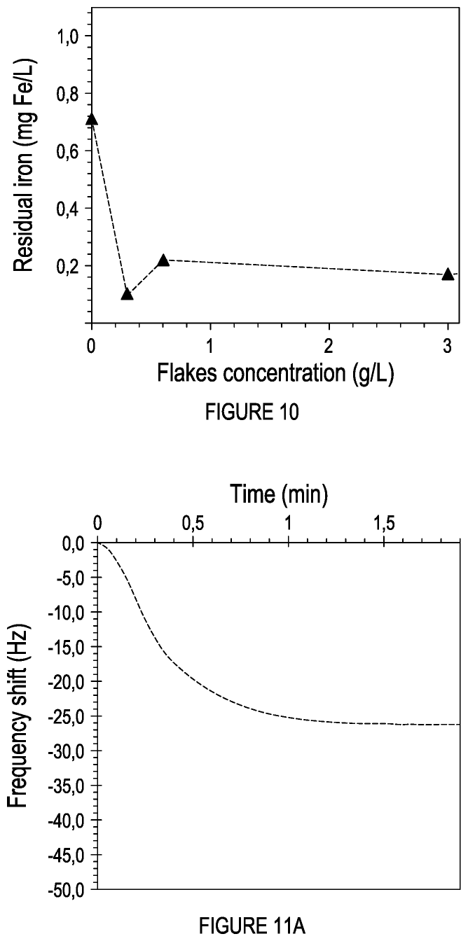

When the fibrous treatment agent is added to the contaminated water, the fibrous treatment agent will associate with the contaminants (soluble and/or colloidal) to form flocs. In one embodiment the flocs formed can remove turbidity and can capture at least one of soluble or insoluble particulates, NOM, phosphorus, nanoplastics, microplastics, total suspended solids (or any other types of soluble molecules, colloids or contaminants), hydrocarbons or other contaminants targeted by the municipal industry or issued from the petrochemical industry (e.g., naphthenic acids, heavy metals (FIG. 10), arsenic (issued from mining, pulp and paper, food industry, agriculture wastewaters/drainage water, petrochemical, or other industries). In one embodiment, the flocs have a size of at least about 1000 μm, of at least about 1500 μm, of at least about 2000 μm, of at least about 2500 μm, of at least about 3000 μm, of at least about 3500 μm, of at least about 4000 μm, of at least about 4500 μm, of at least about 5000 μm, of at least about 6000 μm, of at least about 7500 μm, of at least about 10,000 μm, or of at least 20,000 μm. For example, the flocs can have a size between about 1000 μm to about 100,000 μm, between about 1500 μm to about 100,000 μm, between about 2000 μm to about 100,000 μm, between about 2500 μm to about 100,000 μm, between about 3000 μm to about 100,000 μm, between about 3500 μm to about 100,000 μm, between about 4000 μm to about 100,000 μm, between about 4500 μm to about 100,000 μm, between about 5000 μm to about 100,000 μm, between about 6000 μm to about 100,000 μm, between about 7500 μm to about 100,000 μm, between about 10,000 μm to about 100,000 μm, or between about 20,000 μm to about 100,000 μm. In one embodiment, the term “size” as used in the context of describing flocs refers to the diameter of the floc.

In some embodiments, the fibrous treatment agents according to the present disclosure, particularly the iron grafted fibers, can be used to recover coagulants, flocculants, polymers, and other products or media involved in water treatment such as activated carbon, adsorbent, sand, and ballast media, from sludge. This in turn allows the recirculation and reuse of those agents because they can be recycled along with the fibrous treatment agents as described herein. Consequently, the fiber recirculation can reduce the amount of sludge produced.

In one embodiment, the fibrous treatment agent can be added to the water to be at a concentration of at least about 1.0 mg/L, at least about 10.0 mg/L, at least about 100.0 mg/L, at least about 1.0 g/L, at least about 2.0 g/L, at least about 3.0 g/L, at least about 4.0 g/L, at least about 5.0 g/L, at least about 6.0 g/L, at least about 7.0 g/L, at least about 8.0 g/L, at least about 9.0 g/L, at least about 10.0 g/L, at least about 11.0 g/L, or at least about 12.0 g/L. The fibrous treatment agent concentration depends on the composition of the fibrous treatment agent. For example, fibrous treatment agent with a majority of microspheres and/or flakes may be effective with a smaller concentration than a fibrous treatment agent with a minority of microspheres and/or flakes. Optionally, a further coagulant and/or a further flocculant is added to the contaminated water to improve the aggregation, flocculation and/or coagulation thereby improving the floc size, density, and/or contaminant capture efficiency. However, in one embodiment the method according to the present disclosure reduces the demand in chemicals (coagulants and flocculants).

Once the flocs are formed, the flocs are separated by a physical separation step. In one embodiment, the physical separation step includes or is one or more of sedimentation, decantation, aggregation, settling, screening, sieving, adsorption, gravitational separation, flotation, sludge blanket clarifier, and filtration. For example, the filtration is at least one of granular filtration, membrane filtration, biofiltration, and biosorption. In the case of biofiltration the fibrous treatment agent can be used to form the biofilm on which the microorganisms will grow. The physical separation step can be composed of two or more consecutive or concurrent steps. For example, the physical step can include screening followed by settling. In one embodiment, the gravitational separation includes at least one of ballasted flocculation, flocculation, and air-dissolved flotation. In one embodiment, the physical separation includes passing the contaminated water through a sieve, a screen, and/or a rotating drum. In one example, a screen having pores of at least about 10 μm, 100 μm, at least about 200 μm, at least about 300 μm, at least about 500 μm, at least about 1000 μm, at least about 2000 μm, at least about 3000 μm, at least about 4000 μm, at least about 5000 μm, at least about 10 000 μm, at least about 20 000 μm, or at least about 50 000 μm.

The higher the size and/or density of the flocs, the faster and/or more efficient the physical separation becomes. The fibrous treatment agents according to the present disclosure produce an advantageously large particle/floc (and optionally dense) that improves physical separation in water treatment. In one embodiment, it can optionally allow for major changes in water treatment plant operations by removing the settling tank and relying on screening or sieving to remove the flocs. This can significantly reduce the process footprint, the operation time and costs as well as improve the sustainability of water treatment operations.

Furthermore, the flocs of the present disclosure can be optionally washed to recover and therefore reuse the fibrous treatment agent. After the physical separation step (e.g. settling and/or screening), the fibrous treatment agents are extracted from sludge or from the screen and can be reused several times. For example, i) flocs are fragmented and NOM and particles are partially desorbed and detached from the fibrous treatment agent, ii) cleaned fibrous treatment agent are separated from the sludge by screening, hydrocycloning or other suitable means, and iii) the recovered fibrous treatment agents are reinjected in the treatment tank (e.g. aggregation tank) after cleaning and extraction. Fragmented flocs, desorbed NOM and sludge can be sent for sludge dewatering and drying. The fibrous treatment agent could also be left in the settled/screened sludge to improve the sludge treatment, dewatering, dehydration, or other sludge conditioning.

The present method has many advantages including but not limited to reducing the demand in chemicals (additional coagulants, flocculants and ballasting agent), reducing the required settling time and improving the retention of flocs, allows the screening of flocs to be a self-sufficient separation step, optionally eliminating the settling tank, reusability, sustainability of source materials, reduced cost of materials and operation, improving aggregation kinetics and floc settling rate, improving contaminant adsorption and removal, and reducing alkalinity consumption (and other chemicals), thus sludge production/landfilling is expected to decrease proportionally as coagulant/flocculant usage is decreased. Furthermore, the fibrous treatment agents can be used to improve sludge dewatering, sludge drying, sludge purification, or other sludge treatments.

The fibrous treatment agent can be produced or fabricated from waste materials and resources from different industries (e.g., steel and aluminum industries, food processing, pulp and paper, pharmaceutical, mining and other industries). The fabrication method can optionally include the use of a catalyst, an alcohol and/or silica. The fabrication method can be modified to optimized the fibrous treatment agent's chemical composition, size, density, functional groups, shape, hydrophobicity, mechanical resistance, elasticity, or other physicochemical properties. The optimization can be tailored towards a specific type of contaminant that is generally expected to be present in the water (for example industrial contamination). Thus, the fibrous treatment agents can be modified so as to give specific surface affinities with contaminants, coagulants, flocculants, or other chemicals. In one embodiment, the fabrication method includes the use of dense fillers (e.g., sand, magnetite, recycled crushed glass, or other) to synthesize and to increase the density and/or the size of the fibrous treatment agent. Similarly, in one embodiment, light fillers (e.g., plastic, sugar, salts, anthracite, air, or other) can be used to synthesize, to modify the size, to modify the porosity, and/or to modify the density of the fibrous treatment agent. The fillers can be retrieved from the fibrous treatment agent either by heating and/or by solubilizing (e.g., salt and sugar) and washing (e.g. water). In one embodiment, the fibrous treatment agents are produced on site of the water treatment plant operation (e.g. municipal water treatment plant) using waste fibers (e.g. from bathroom tissue, or other fibers such as polyester, cotton, nylon, keratin).

Additional advantages of the fibrous treatment agent of the present disclosure include: (a) reducing the demand in coagulant and flocculant, (b) improve sludge dewatering, sludge drying, sludge purification, or other sludge treatments, (c) improve process sustainability, to reduce capital/operational expenditures or to reduce the process footprint, (d) reduce the concentration of contaminants in treated water.

### Example 1 Synthesis Methods and Characterization of Exemplary Fibrous Treatment Agents

1.1 SiO₂-Fibers and SiO₂-Microspheres Synthesis and Characterization

Different types of fibers were used for the grafting: cotton fibers (textile industry), polyester fibers (textile industry), nylon, keratin-based fibers, pristine fibers, low-cost recycled and deinked fibers from the pulp and paper industry, fibers (bathroom tissue) contaminated by municipal wastewater (influent from the city of Montreal, Canada), and other fibers. To simulate the fibers saturation with wastewater, 1 g of pristine fibers were soaked in 1 L of wastewater (city of Montreal) during 24 h at room temperature. Fibers were subsequently extracted from wastewater. Briefly, the solution was firstly screened with a 2000 μm (or more) nylon screen to remove larger aggregates and secondly intensively mixed at 1000 rpm (pH 4.5) with a magnetic stirrer to break aggregates attached to fibers into filterable particles. Fibers were subsequently collected using a 160 μm sieve, while the previously fragmented particles passed through the sieve. Using this technique, only long fibers with a high bridging potential are collected. Other fibre types such as cotton, polyester and keratin-based, all present in wastewater influent, were also used as bridging materials. Prior the grafting SiO₂ procedure, all fiber types were washed in water and dried at 40° C. for 24 h prior to carrying out the Si grafting reaction described elsewhere. Tetraethoxysilane (TEOS) was used as the reagent, and phosphotungstic acid (H₃PW₁₂O₄₀) as the catalyst were added to the pulp dispersion. The mixture was then vortexed to achieve a well-mixed dispersion before setting it to stir for 24 h at room temperature. The grafted SiO₂-fibers were then separated from the solvent using a 160 μm sieve and rinsed twice with water to remove any residual unreacted reagent and catalyst.

During the synthesis, SiO₂-fibers (used in FIG. 2F, center) and SiO₂-microspheres (used in FIG. 2G, right) are simultaneously generated. Grafting silica sealed/stabilized the initial morphology of the fiber-based aggregate. Consequently, to foster the formation of SiO₂-fibers, the pulp must be properly dispersed to obtain a homogenous suspension of free fibers before the reaction with silica (with tetraethyl orthosilicate (TEOS)). Inversely, to promote the formation of stable and larger aggregates (SiO₂-microspheres), the dried pulp was simply manually grinded (i.e., the shape and the aggregate size is tunable) before grafting silica. The amount of grafted SiO₂ and the relative proportion of SiO₂-microspheres vs. SiO₂-fibers obtained after synthesis could also be adjusted by modifying the ethanol/water and TEOS/water ratios, and by modifying the fibers concentration during the synthesis. To evaluate and clearly differentiate the impact of each material on water treatment, the SiO₂-fibers were separated from the SiO₂-microspheres by gravitational separation. The fibers and microspheres formed were shown to be stable in water and tolerated high shearing (velocity gradients as high as 1000 s⁻¹). The compositions of pristine fibers (control) and grafted materials were also characterized using Fourier-transform infrared spectroscopy (FT-IR, Spectrum II, PerkinElmer) with a single bounce-diamond in attenuated total reflection (ATR) mode. The morphologies of all materials were obtained using scanning electron microscopy (SEM, FEI Quanta 450) coupled to energy dispersive x-ray spectroscopy (EDS).

### 1.2 Flake Synthesis and Characterization

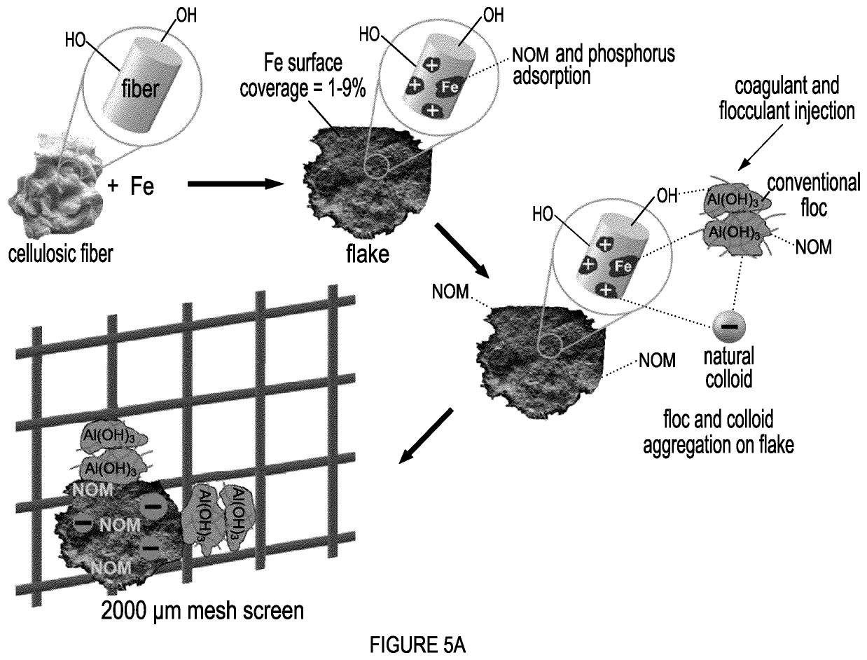

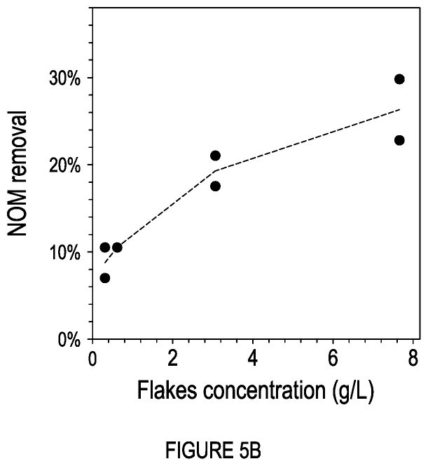

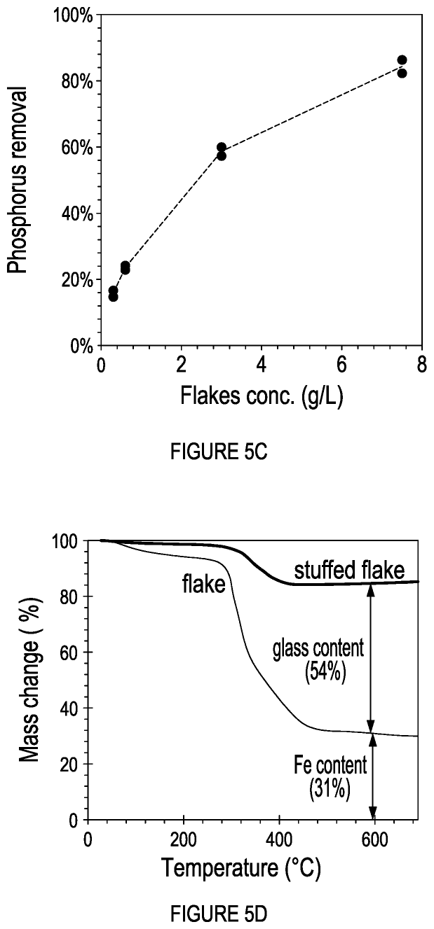

A three-in-one material (flakes, used as coagulant, flocculant and ballast medium; FIG. 2G) was synthesized by using a sustainable and low-cost method. 1 g of recycled fibers was washed twice in water and air-dried for 24 h. After being washed, fibers were injected into FeCl₃ solution, or other metal salts and/or polymers. The suspension was adjusted at different pH and stirred during 5 min. The grafted fibers were separated from the solution with a 160 μm sieve and were heated during 0.1-24 h (or more). The Fe surface coverage is tunable by adjusting the FeCl₃ concentration during the synthesis. Contrarily to SiO₂-microspheres, the flakes did not require ethanol, a catalyst and TEOS for their synthesis. SEM-EDS was used for characterization. The dried pulp was fragmented into large aggregates to improve the removal during screening. To increase the mechanical resistance of flakes, organic polymers were added before heating. Grafting Si or polymers on the flakes external structure was used as another method to improve the mechanical resistance. Dense filler (e.g. sand, crushed glass, magnetite, or other dense media) were added to the fiber-based aggregates to increase the material density and settling velocity (FIG. 5D). Salts or sugar particles (or light fillers) were also added during synthesis to increase the material porosity; some of those fillers were solubilized and washed out from the flake by using water.

### 1.3 Other Syntheses

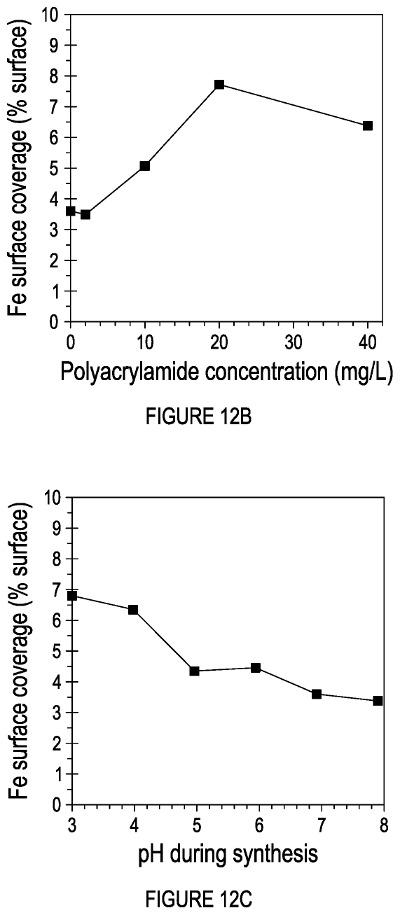

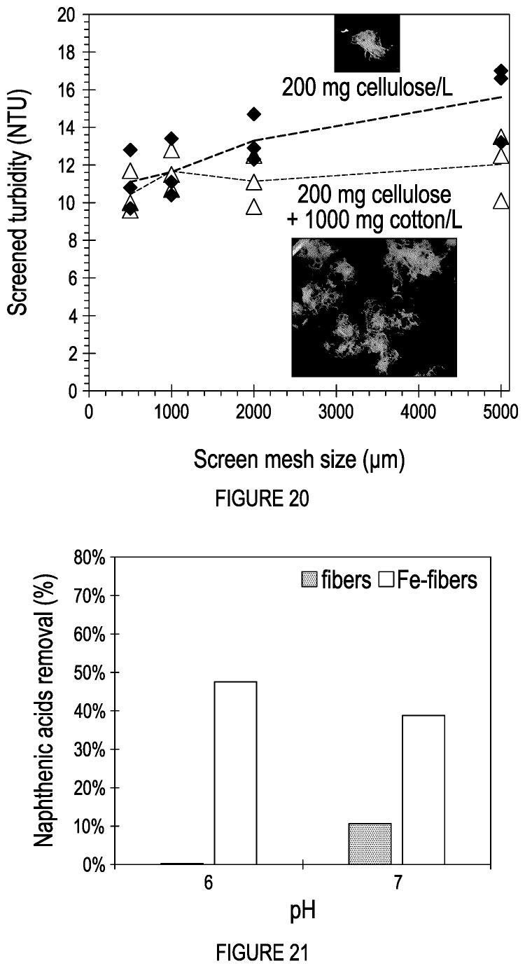

Different type of fibers (cotton, keratin, cellulosic fibers and polyester, dryer lint, and other fibers from the textile, pulp and paper, food, mining, pharmaceutical industries, agriculture (FIG. 20), etc.) were used. All those fibers were also functionalized/grafted and/or rearranged into fibers-based materials (microspheres, flakes or other morphological arrangement) using several (hydr)oxides (Al(OH)ₓ (e.g., from alum; FIG. 16), Fe(OH)ₓ, Al₂O₃, Fe₂O₃, CaCO₃, Fe₃O₄, FeOOH, SiO₂, TiO₂ and ZnO, etc.) and many polymers (polyamines, polyacrylamide (FIG. 16), polydiallyldimethylammonium chloride, epichlorohydrin/dimethylamine, polysaccharides-based polymers, etc.). Some chemicals and wastes materials were also collected from the textile, pulp and paper, food, mining, pharmaceutical and from other industries. The syntheses were performed at different temperature, metals concentration (FIG. 12A), polyacrylamide concentration (FIG. 12B and FIG. 16), and pH (FIG. 12C) and with different solvents, catalysts, etc.

### 1.4 Tracking Conventional Indicator During Water Treatment (Jar Test)

Water samples were first coagulated with alum (or other coagulants) and then flocculated with an organic polymer (or other chemicals). Fibers, SiO₂-microspheres or flakes and other fiber/materials were injected at the onset of flocculation (i.e., after the coagulation). Turbidity measurements were assessed after sieving/screening using different nylon screens mesh sizes (100, 500, 1000, 2000 and 5000 μm). Other mesh sizes and other materials than nylon could be used. Turbidity measurements were also assessed after settling. All screened and settled samples were collected at a depth of 2 cm from the top of the water surface. Floc sizing was performed at the end of flocculation using a stereomicroscope (10×; Olympus, model SZX16). Aftertreatment, all materials were extracted from the screen or settled sludge, washed and reused several times in the processes (to reduce the operational expenditure). Jar test experiments were conducted using surface waters, wastewaters, municipal wastewaters, domestic wastewaters, and synthetic wastewaters. Screened and settled floc solutions were collected and adjusted at different pH to promote the floc fragmentation and NOM desorption. The solution was then mixed and the fibrous treatment agents were collected using different mesh sizes. Materials were then reused for subsequent jar tests.

### Example 2 Impact of the Fibrous Treatment Agent on Settling

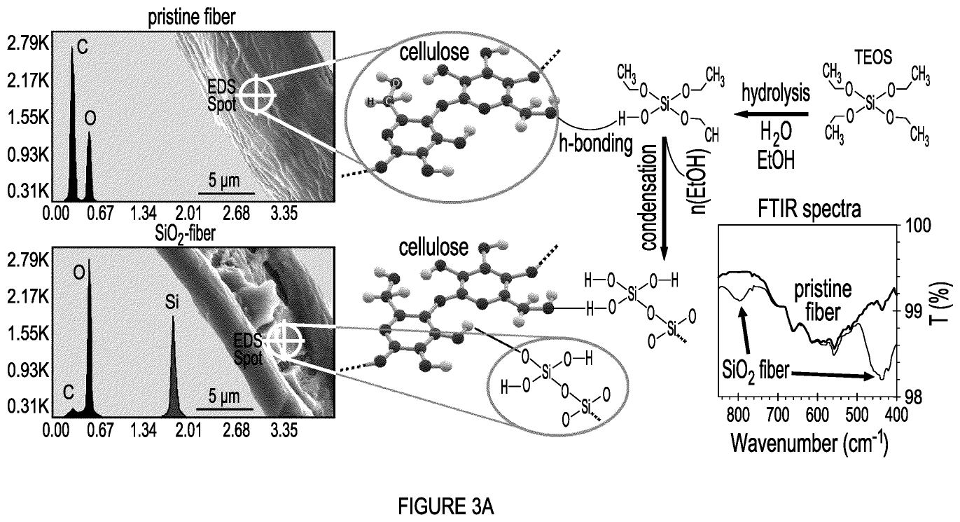

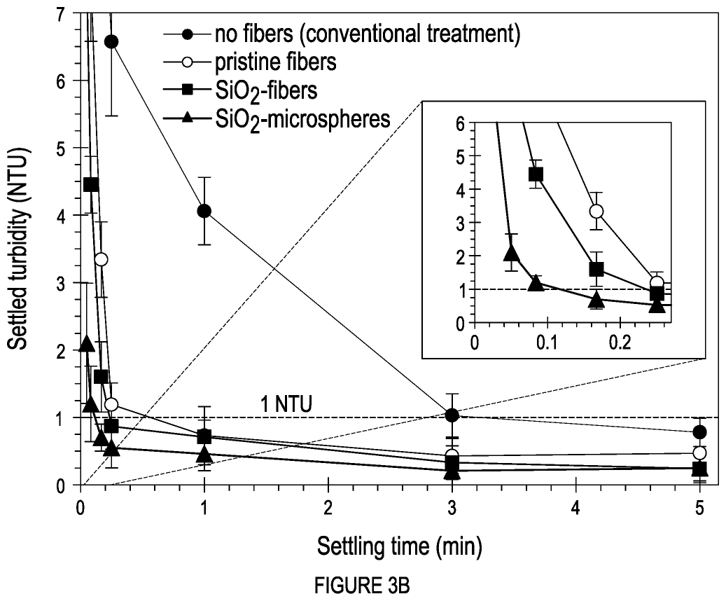

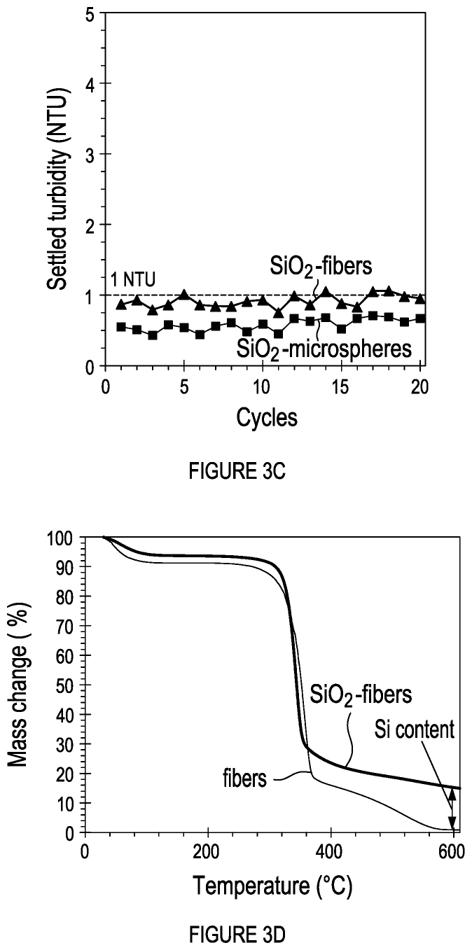

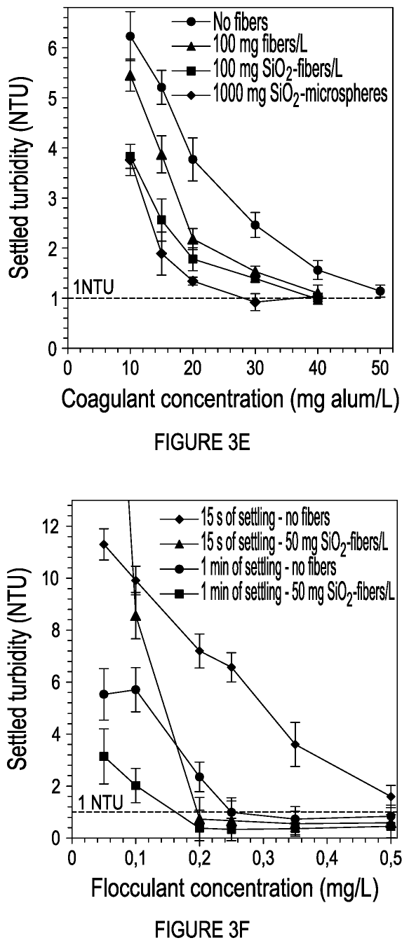

The fibrous treatment agents, used as bridging agents during aggregation, were grafted with different (hydr)oxides (e.g., silica oxide (SiO₂)) to increase the agent's specific gravity (density), to modify the fiber hydrophobicity/hydrophilicity and to modify affinities with contaminants or coagulants/flocculants (FIG. 3A). The presence of Si (0-70 w/w %, or higher) on fibers was confirmed by FT-IR (FIG. 3A) and thermogravimetric analysis (TGA) (FIG. 3D). Grafting Si (or other hydr(oxides)) on fibers also allowed to morphologically rearrange fibers into fiber-based aggregates (e.g., microspheres, or other shape). The SiO₂-microspheres simultaneously used as super-bridging-ballasting agents and as adsorbents are significantly more porous than mineral sands (silica and magnetite) used globally in ballasted flocculation, hence offering a higher surface area per gram of material.

Increasing the floc size by bridging particles together is a key element in water treatment as it determines the floc settling velocity and contaminant removal rates. The flocculant effective chain length or hydrodynamic volume (dictated by its molecular weight and architecture) are good indicators of a flocculant's potential in aggregation processes. Synthetic flocculants such as polyacrylamide (theoretical chain length<100 nm) are used worldwide to increase the floc size. For the tested water, a floc mean diameter of 520±50 μm was measured for conventional treatment (coagulant and flocculant, without fibers or fiber-based materials). However, when used as super-bridging agents and having a structure considerably longer than traditional flocculants, SiO₂-fibers generated flocs with unprecedented size: 4950±480 μm (or larger), more than 10 times larger than flocs obtained with the conventional treatment. As shown in FIG. 2E, the bridging effect mentioned above was not observed when nanofibers (length of <200 nm) or microfibers (length of <10 μm) were used instead of the fibrous treatment agent. For the tested waters, fibers of 10-100 μm showed a slight improvement in turbidity removal.

In FIG. 3B, the performance of pristine fibers during settling is compared to conventional treatment; higher removal rates are observed with pristine fibers. Due to their higher density, we also show that SiO₂-fibers are even more efficient than pristine fibers during settling (FIG. 3B). However, the flocs formed with SiO₂-microspheres were considerably larger compared to those obtained with other approaches (>6000 μm). The required settling time to reach 1 NTU dropped considerably when SiO₂-microspheres were used. In this case, a considerably smaller (i.e. more sustainable) settling tank could be built without affecting the turbidity removal. This latter material would consequently completely change the process cost as compact treatment plants tend to be most economical.

Due to their super-bridging effect, the tested fibers and microspheres (or other fiber-based materials) also allowed a reduction in coagulant/flocculant demand. This translates into a reduction in sludge production, hence decreasing the burden of its physical transport to landfills. Finally, we showed that SiO₂-fibers and SiO₂-microspheres (or other fiber-based materials) can be extracted, washed and reused several times in the process (at least 20 times) without affecting the solids removal (FIG. 3C).

### Example 3 Impact of the Fibrous Treatment Agent on Screening

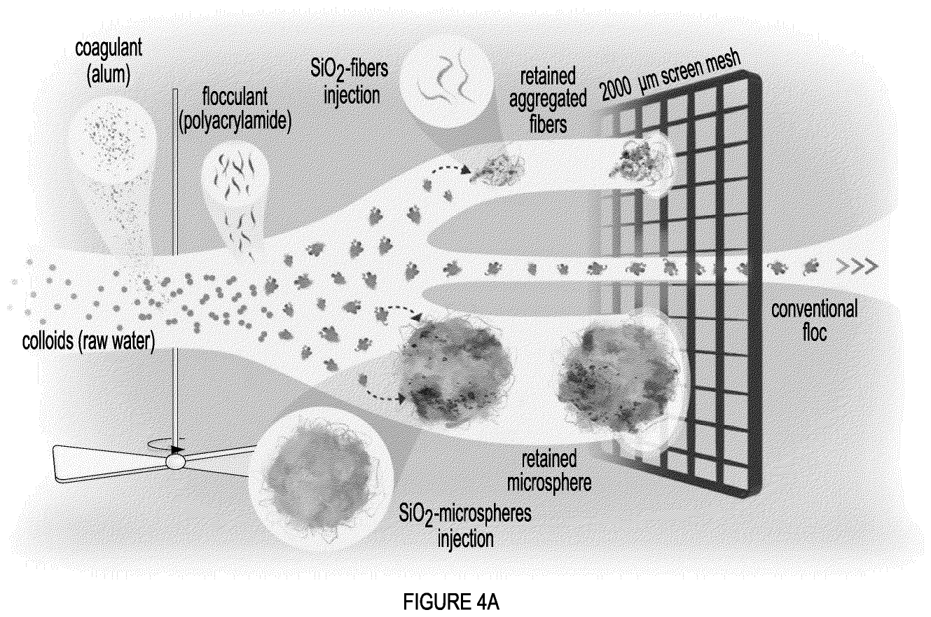

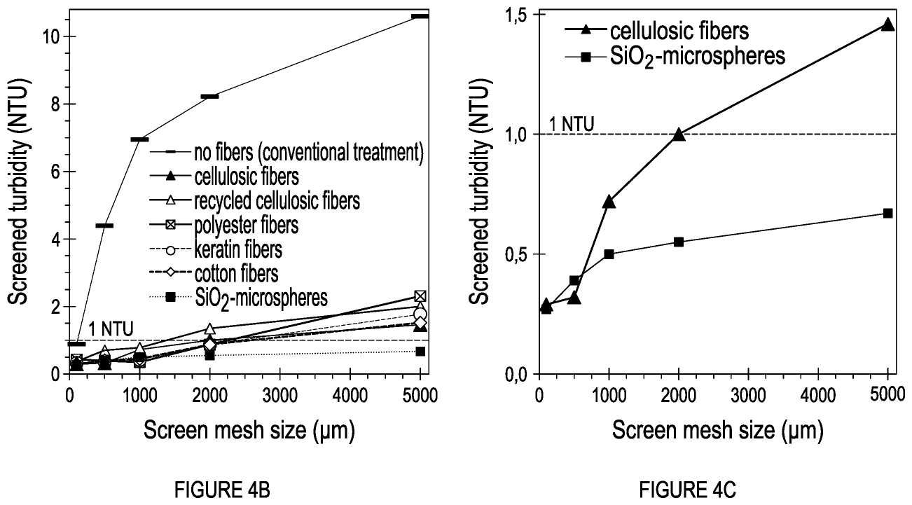

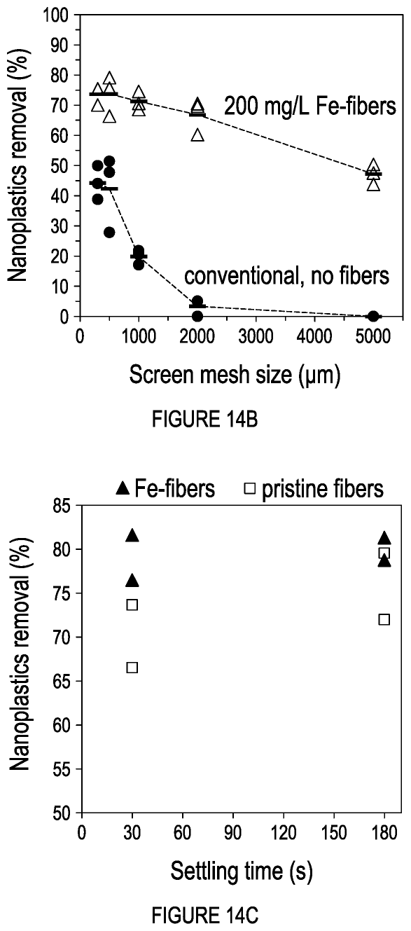

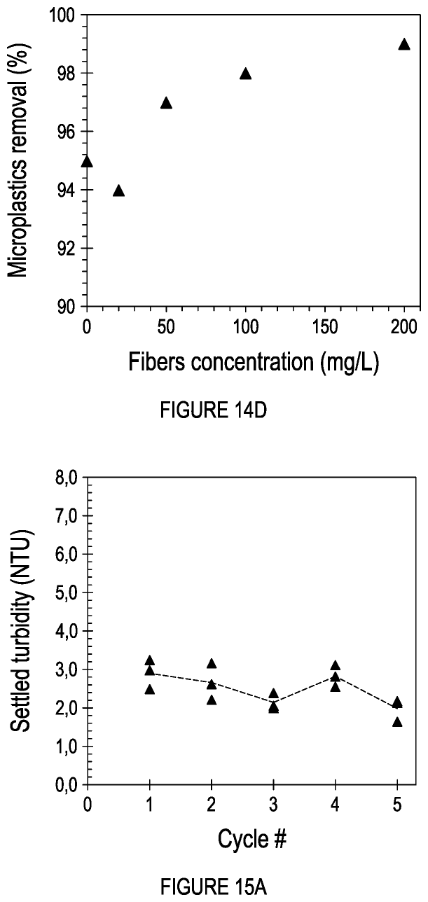

For decades, engineers and researchers have used a systematic approach to reduce the settling tank size, cost and footprint: increasing—as much as possible—the floc settling velocity. With the floc size according to the present disclosure that can be obtained with fibers, grafted fibers and fiber-based material (used as bridging agent), screening methods can be implemented as more sustainable and cost effective strategies for floc removal. A key advantage of screening versus settling is that floc removal is not controlled by the floc settling velocity, but rather by its size. The unprecedented size of the flocs formed by using SiO₂-fibers and SiO₂-microspheres (or other fibrous treatment agents according to the present disclosure) allows considerable increases in the screen mesh size (with lower risks of clogging) without affecting the floc removal by screening, while conventional flocs would readily pass through the same mesh size (FIGS. 4A, 4B and 4C). The efficacy of fibers combined with screening is also presented in FIG. 14A (turbidity removal) and FIG. 14B (nanoplastic removal), for wastewater applications.

Water treatment using SiO₂-fibers and SiO₂-microspheres successfully reached 1 NTU event with large mesh size: 2000 and 5000 μm mesh (or other) were required for SiO₂-fibers and SiO₂-microspheres, respectively, while conventional treatment required a much finer mesh of 100 μm (FIG. 4B). We also produced larger SiO₂-microspheres (e.g., 30 000 μm, or larger), by modifying the synthesis conditions; industrial screens could hence be designed with a larger mesh size than those demonstrated herein. Designing with larger mesh sizes reduces clogging by limiting screen pore blocking, increases the filtration effective area (i.e., total area between the clean meshes) and reduces the required capital expenditures of the process by replacing the traditional settling tank. Moreover, screens with larger mesh size can be periodically cleaned by a simple pressurized air system (without water).

After being trapped, the aggregated fibers and microspheres were retrieved from the screen, cleaned and reinjected in the aggregation tank. Other types of fibers promoting aggregation such as keratin-based fibers (cotton and polyester (textile) and other fibers were used as alternatives to cellulosic fibers). All the tested fibers reached the −1 NTU target during screening (FIG. 4B). Combinations of fibers were also used to produce very large flocs (>30,000 μm; FIG. 20).

### Example 4 Impact of the Fibrous Treatment Agent on Contaminant Removal and on Chemical Demand

The water treatment industry currently uses three classes of additives for high-rate clarification processes: coagulant, flocculant and ballast media. Technico-economically and for large water treatment plants, aggregation/settling is still the most efficient and common way to remove NOM from surface water, the coagulant concentration being in many cases driven by the residual NOM after treatment (or other target contaminants in wastewater). As a cheap and sustainable solution to existing practices, flakes (metal (hydr)oxides grafted on fibers), or other porous/filamentous fiber-based materials, can serve as a three-in-one coagulant/flocculant/ballast medium that can simultaneously remove soluble contaminants (e.g. NOM and P) by adsorption (FIGS. 5A, 5B and 5C), reduce turbidity by bridging colloids and improve the sieving/settling removal rate by increasing the floc size/density. Many fiber types and binding agents could be used for the synthesis of functionalized fiber-based aggregates/materials. Herein, as an example, we use cellulosic fibers grafted with Fe. For this example, the surface coverage of Fe was measured to be 1-9% (via XPS), but higher surface coverage could be used by optimizing the synthesis (FIG. 12).

FIG. 5A summarizes the synthesis, the adsorption/aggregation pathways and the advantages of the fabricated flakes. Flakes reduce the coagulant and flocculant demand (during screening and settling). Sludge production and landfilling would also be proportionally reduced as they are largely controlled by the coagulant and flocculant dosages. Flakes also adsorbed soluble phosphorus during municipal wastewater treatment (FIG. 5C). By using flakes combined to coagulant and flocculant during screening, we systematically measured turbidity removal>93%. Such large and dense flakes also eliminate the need for non-renewable and unsustainable ballast media (e.g. silica and magnetite sands extracted from natural geological sites) during settling. However, for future water treatment plants, the formation of very large flakes (the size is tunable) would allow replacement of the costly settling tank (˜20% of the total plant construction cost) with a compact screening process.

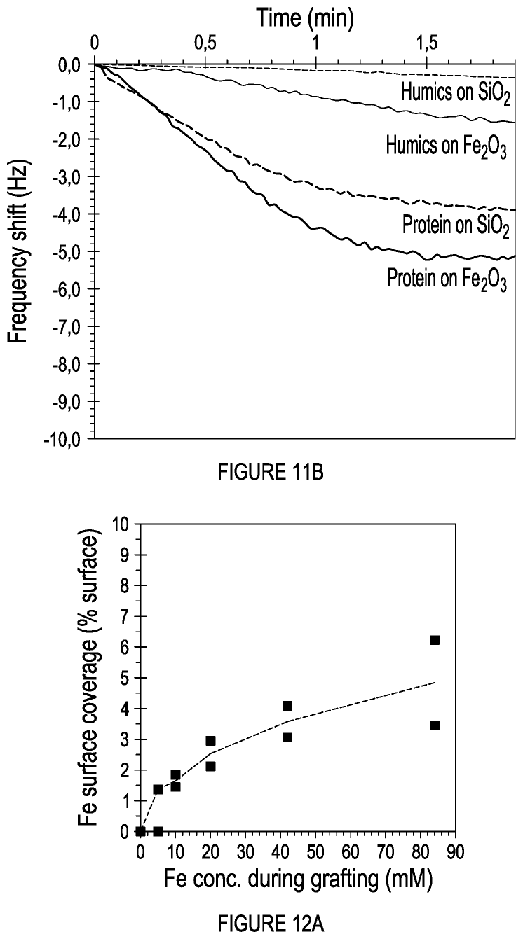

Finally, reinforced flakes can also be fabricated with either a high molecular weight polyacrylamide or SiO₂ to improve the mechanical resistance over time and during high-shearing events (e.g. in mixing tank). Flakes were shown to be relatively resistant to shearing. The fiber-based aggregates' structure could also be grafted with other metal (hydr)oxides or polymers to increase the durability, to improve biofilm formation/attachment for biological treatment (FIG. 11A), and/or to target specific contaminants during adsorption: arsenic on Al, Fe and Zn oxides, heavy metals (FIG. 10) on Fe oxides, perfluorooctane sulfonate on Al, Cu, Fe and Ti oxides, phosphate on Al, Fe and Mn oxides, colloid attachment on grafted high molecular weight flocculant, etc. Fiber-based materials are also expected to improve sludge dewatering and reduce the chemical demand during sludge treatment.

Dense media (e.g., sand, crushed glass, magnetite, or other) were also used as filler to increase the density and the settling velocity of fiber-based materials (FIG. 5D). Inversely, light media were used to decrease the density and improve flotation process. Salt and sugar particles were also used during synthesis and rinsed afterward. Once the salts or sugar are extracted from the fiber-based materials by solubilisation, the porosity of the material was increased.

### Example 5 Pristine, Iron Grafted, and Polymer-Grafted Fibers as Fibrous Treatment Agents

Chemicals were obtained from Sigma-Aldrich. 1 g of cellulose fibers (referred in the present and subsequent examples as “fibers”) (NISTRM8496 Sigma-Aldrich; fibers diameter: 4-40 μm; fibers length: 10-2000 μm) were added in 100 mL alum or ferric sulphate solution at pH 7 (iron concentration: 0.06-42 mM). Fibers were then removed from the solution using a 160 μm sieve and heated (50-150° C.) for 0.1-6 h to convert Fe(OH)₃ into FeOOH/Fe₂O₃, or other oxides and/or hydroxides. After heating, the dried pulp iron-grafted fibers were mixed and re-dispersed in water, and then rinsed 3 times to remove the loosely bound metal or other (oxides and/or hydroxides. FIG. 9 shows a Fe content of ˜15-30% fora representative synthesis (obtained by thermogravimetric analysis (TGA)).

Different concentrations of Fe-grafted fibers were tested: 0, 10, 20, 50, 100, 200, 350 and 500 mg/L. Screens with different mesh size (5000, 2000, 1000, 500 and 100 μm, Pentair™) were used to remove flocs from water. The turbidity was measured after screening or after 5, 10, 20, 60 and 180 sec of settling. After treatment, fibers were recovered from screened and settled water to be reused several times (at least 4).

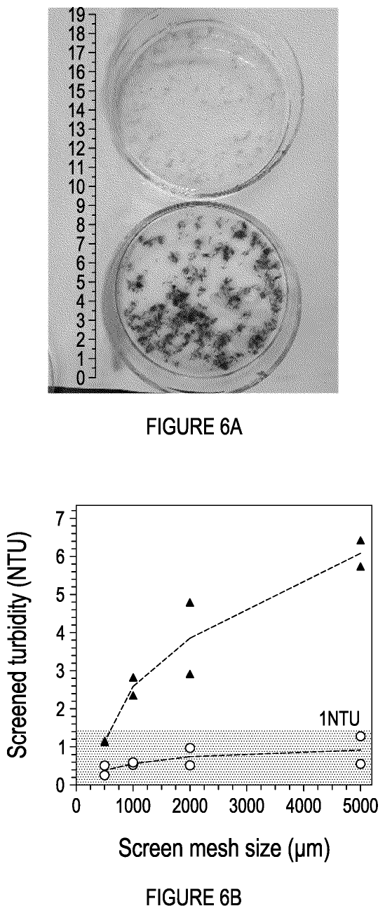

As shown in FIGS. 6A and 6B the Fe-grafted fibers increased the size of flocs and improved floc removal during screening compared to conventional treatment (coagulant and flocculant). FIG. 6A shows the increase in floc size in the presence of the iron grafted fibers which is so significant that it can be visualized with the naked eye. In FIG. 6B 100 mg/L of iron grafted fibers were used (Alum: 30 mg/L. Polyacrylamide: 0.3 mg/L) and a treatment according to the prior art. As shown in FIG. 6B the treatment with the present fibers demonstrated an improvement over the prior art method across all tested mesh sizes.

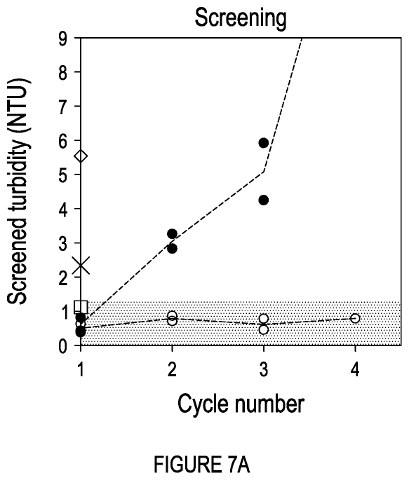

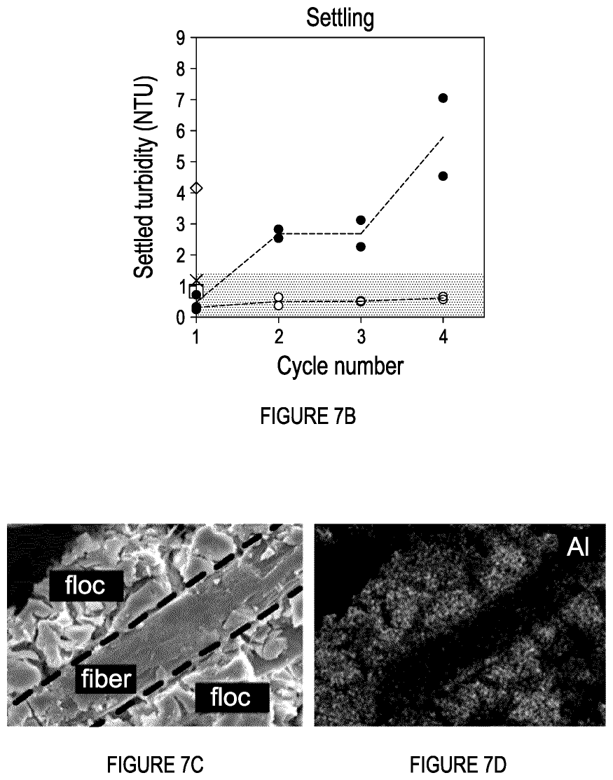

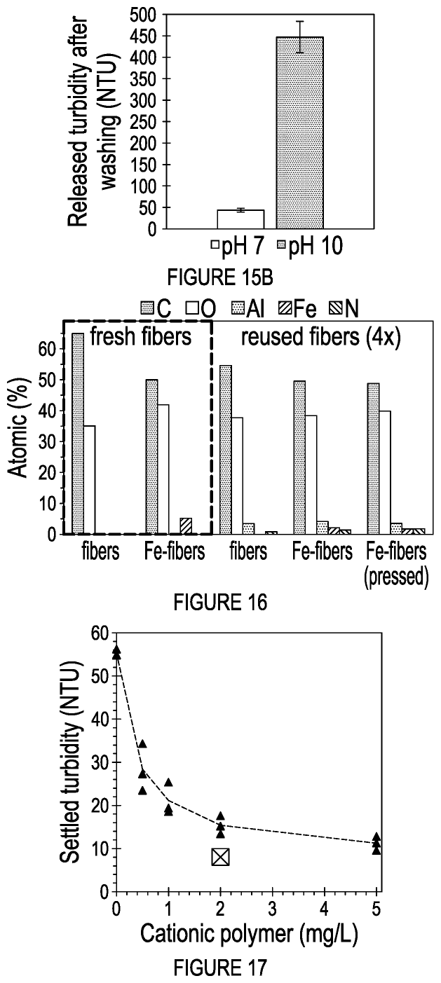

To reduce the operating expenditures (OPEX) and the water treatment plant footprint, Fe-grafted fibers coated with coagulant and flocculant were reused several times in the process to reduce the demand in coagulant and flocculant. Consequently, coagulant and flocculant previously added in the treatment can be extracted from sludge (after settling or screening) and be recirculated in the process via the fibers. Thus, the fibers act as carriers to recirculate chemicals used in water treatment (e.g., coagulant and flocculant). When Fe-grafted fibers were used in combination with alum in FIGS. 7A and 7B, the turbidity remained stable with only 10 mg alum/L, while 30 mg of alum/L was required in the system without fibers (cf cycles 1-4 in FIGS. 7A and 7B). The treatment performed was a screening with a 500 μm (FIG. 7A) or a 3 min settling (FIG. 7B). Fe-grafted fibers coated with coagulant extracted from sludge were reused several times to reduce coagulant demand. The reduction in coagulant demand is possible because the coagulant was still attached to the fibers, and consequently reinjected in the subsequent cycle via the fibers. This can be seen in FIGS. 7C and 7D. In all cycles, 0.4 mg polyacrylamide/L was added. The reduction in coagulant demand due to the fiber recirculation can enable a reduction in sludge production. The fiber reusability (FIG. 15A), washing (FIG. 15B), and impact on recirculating the coagulant and flocculant (FIG. 16, even after pressing the fibers with a press filter; far right) were also tested for wastewater applications. In FIG. 16, after being extracted from sludge, the fibers were also used as carrier to recirculate coagulant (alum) and flocculant (polyacrylamide) in the aggregation tank.

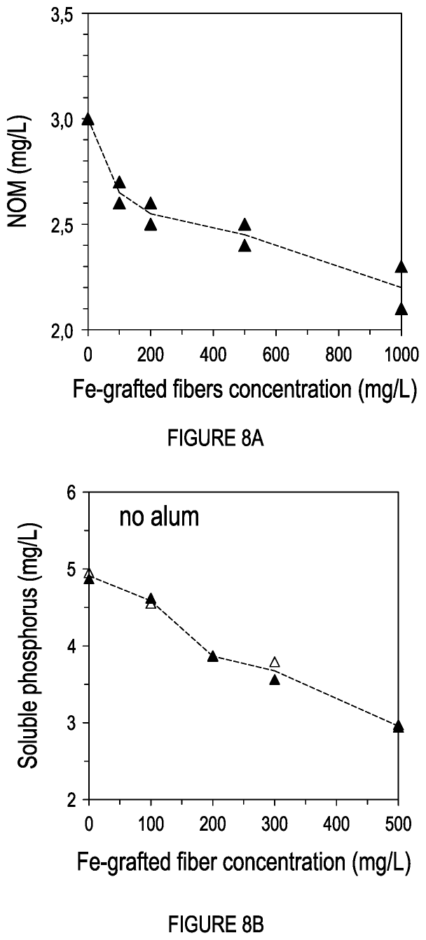

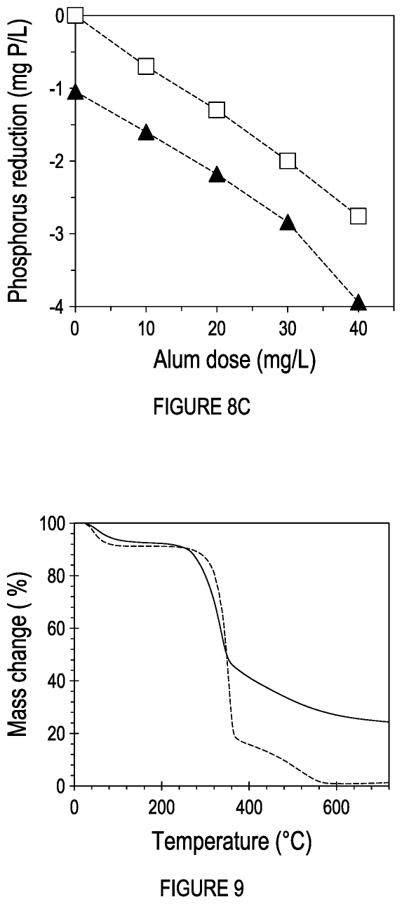

The Fe-grafted fibers demonstrated an excellent performance at removing natural organic matter NOM, phosphorus (P) (FIGS. 8A-8C).

As shown in FIG. 10, a heavy metal contaminant removal (e.g., iron) of 86% was achieved when 0.3 g flakes/L was used during wastewater treatment (pH 7.4). The heavy metals removal is possible via interactions with the metals grafted on fibers or via fibers functionalized with carboxyl, sulfonated or phosphorylated groups. Other elements removal was achieved when 0.2 g iron-grafted fiber/L (combined to alum and polyacrylamide) was used during domestic wastewater treatment (pH 7.2): Al (16%), Ba (100%), Cu (33%), Fe (51%), Mn (23%), Ni (100%), Pb (40%), and Zn (20%) (measured by ICP; average value obtained from replicates).

Due to their high surface area, porosity and grafted metals/or functionalized groups, fibrous materials can also support and improve biofilm formation and biological growth. Moreover, as confirmed by high deposition rate measured by quartz-crystal microbalance (QCM) (FIG. 11A), Fe (hydr)oxides were shown to strongly interact with extracellular polymeric substances (EPS) (pH 7), which would accelerate biofilm formation thereby improving biological treatment involving biomass (e.g., activated sludge, biofiltration, anoxic treatment, anaerobic treatment, etc.).

Fibrous materials could be tuned to promote the adsorption of specific contaminants for drinking and wastewater applications. For example, Fe-based surface better adsorbs different NOM fractions (protein and humics) compared to Si-based surface, as shown by deposition rates measured by QCM (FIG. 11B).

The amount of metal grafted on fibrous materials can be controlled by adjusting the metal concentration (FIG. 12A; pH 7, no polyacrylamide; dashed line represents the average value obtained from duplicates), the polyacrylamide concentration (FIG. 12B, 42 mM Fe, pH 7), and the pH (FIG. 12C; 42 mM Fe, no polyacrylamide) during synthesis.

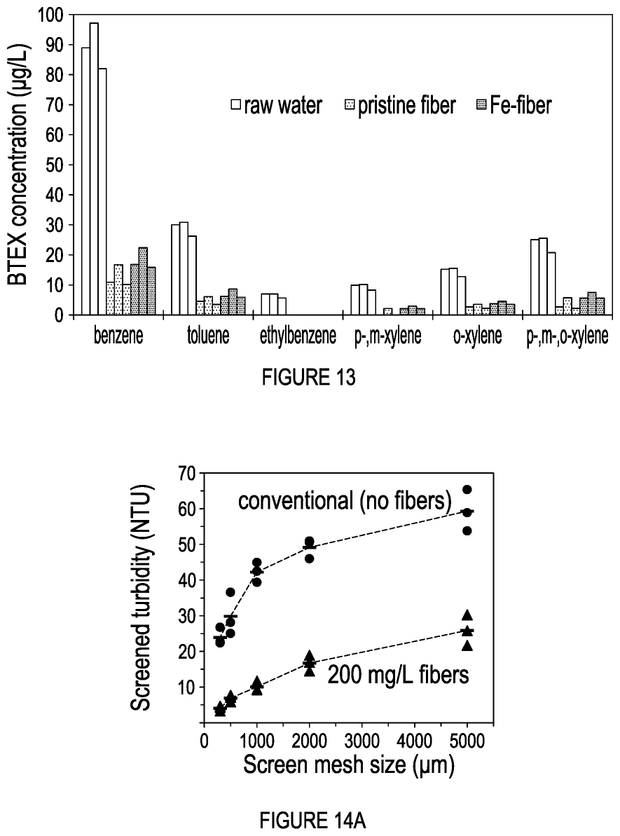

Benzene, toluene, ethybenzene, p-, m-xylene, and o-xylene (BTEX) removal was evaluated. The pristine and Fe-grafted fibers removed on average 88% and 80% of all the BTEX, respectively (FIG. 13). Both types of fibers adequately removed ethylbenzene (100% removal), while the removals for o-xylene were the lowest (75-81%). Based on these results, fibers could be added into existing processes as a cheaper alternative to conventional adsorbents (e.g., activated carbon and resin) to deal with sudden contaminant peaks or accidental hydrocarbon spills (or other contaminants) that contaminate waters.

Removal via screening was shown to be efficient for the treatment of surface water for a drinking water application. FIG. 14A shows that screening combined with fibers is efficient for the removal of turbidity during wastewater treatment. FIG. 14B shows that screening combined with fibers is efficient for the removal of emerging contaminants (e.g., nanoplastics) during water treatment. FIG. 14C shows that settling combined with fibers is efficient for the removal of emerging contaminants (e.g., nanoplastics) during water treatment. Fe-grafted fibers exhibited higher nanoplastics removal than pristine fibers. FIG. 14D shows that the presence of fibers improved microplastics removal from 95% to 99%.

FIG. 15A shows that fibers can be extracted from sludge and reused several times without affecting the turbidity removal (turbidity removal>95% for cycles 1-5). 200 mg fibers/L were added at cycle 1 and the same fibers were reused for cycles 2-5 (without being washed or regenerated).

After 5 cycles of water treatment with fibers, the Fe-fibers were washed at pH 7 and 10 to remove contaminants (FIG. 15B). Washing at pH 10 promoted the detachment of colloids/flocs and the regeneration of fibers: the released turbidity from the fiber surface increased from −40 to 450 NTU at pH 7 and 10, respectively.

Based on XPS analysis performed on fibers used 4 times (extracted at cycle 4), pristine and Fe-fibers have (positively charged) amine groups and aluminum (hydr)oxides attached to their surfaces that arise from cationic polymer (polyacrylamide) and alum, respectively (FIG. 16). Consequently, both types of fibers can be functionalized with coagulant and flocculant and both types of fibers act as a carrier to recirculate alum (Al % atomic of 3.5-4.2%) and polyacrylamide (N % atomic of 0.8-1.8%).

FIG. 17 shows that cationic polymers (e.g., polyacrylamides or quaternary amine-based polymers) are easily attached and can functionalize the fiber surface. Pristine fibers were used during aggregation without metal-based coagulant and without anionic flocculant. Formulation of fibers and cationic polymers were used to remove 86% of the turbidity (aggregation of 8 min). A removal of 73% was measured after 2 min of aggregation. Such fibers and polymers (or other chemical formulations or combinations) could be used in biological treatment (e.g., activated sludge), or any other aggregation and separation method that don't usually require metal-based coagulants such as alum or ferric sulfate.

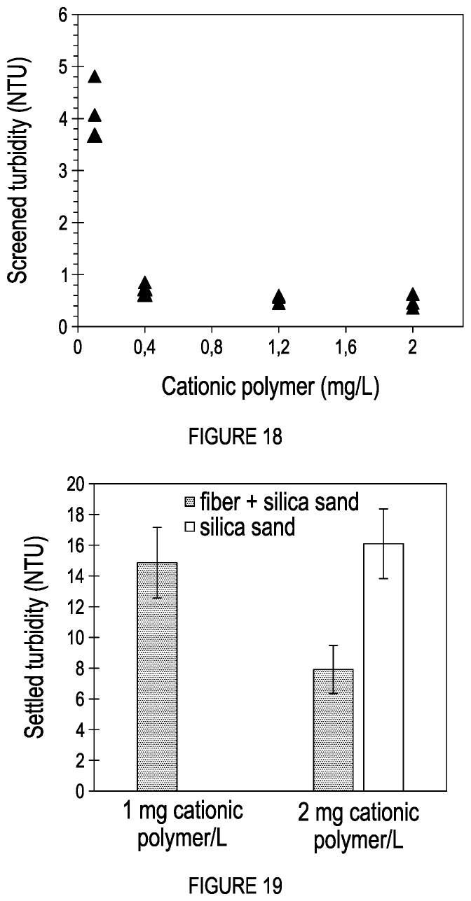

A formulation of fibers and cationic polymers was used to treat a surface water in order to produce drinking water via a compact separation process (no settling was required; FIG. 18). After 8 min of aggregation, the large flocs were pressed with a 500 μm screen mesh. Very low turbidity of <0.3 NTU was obtained after pressing. Pressing was shown to be more robust, more stable and generated lower turbidity than settling. Consequently, this system could be used to produce drinking water or treat wastewaters, notably for remote communities, or for decentralized treatment, and any other types of water that need to be treated in batch e.g., domestic wastewater, ship ballast water, etc. Fibers and polymers in formulations could be injected sequentially or simultaneously (e.g., pods or chemicals blended in pucks), and be combined with any kind of separation methods and collector (e.g., 3 dimensional porous collector). The press filter system was also used for sludge dewatering to produce sludge with lower water content.

When pristine fibers were used, sludge solid content was 20% after settling (3 min) and 37% after pressing (500 μm mesh size). The presence of the fibrous treatment improved sludge dewatering. Solids content of sludge without fibers could not be increased by pressing as flocs were too small and readily pass through the mesh structure.

FIG. 19 shows that fibers used in combination with ballast media (silica sand) improved settling (settled turbidity of 7.9 NTU; 86% removal) compared to when ballast media are used alone (settled turbidity of 16.1 NTU; 71% removal).

FIG. 20 shows that cellulose fibers (mean length: 1000 μm) used in combination with cotton fibers (mean length: >10,000 μm) considerably increased the floc size (see FIG. 20) and improved the removal of turbidity during screening (screen mesh size of 5000 μm): screened turbidity of 12 NTU (79% removal) with cellulose combined with cotton, and screened turbidity of 16 NTU (71% removal) with cellulose fibers used alone. Blends of different types of fibers and of different lengths, injected simultaneously or sequentially, such as cotton, cellulose, lignin, cellulose, polyester, polysaccharides-based fibers, or any other fibers could be used in combination to increase the floc size and improve contaminant removal by screening, settling, or other separation methods. Moreover, fibrous agents, or combinations of fibrous agents were shown to accelerate the formation (faster kinetics) of flocs compared to conventional treatment without fibers. In FIG. 20, only 20 sec was required to form very large flocs while conventional treatment required typically more than 4 min.

Fibers from agriculture residues (e.g., maize) were successfully used as fibrous agents (data not shown). Such fibers were grafted with metal (6.5% Fe; obtained by XPS) to provide new adsorption sites for contaminants.

FIG. 21 shows that Fe-grafted fibers were more efficient than pristine fibers for the removal of naphthenic acids.

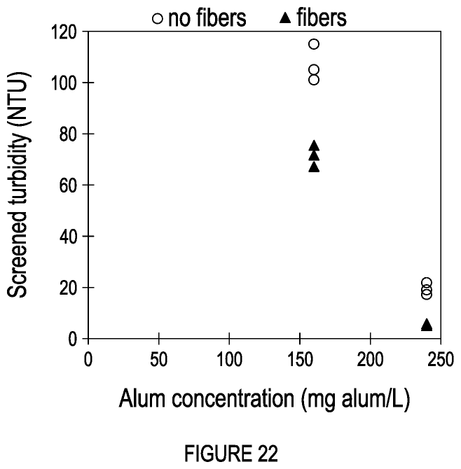

FIG. 22 shows that fibers drastically improved the removal of turbidity during screening for domestic wastewater: screened turbidity of 19 NTU and 5 NTU with conventional treatment and fibrous treatment, respectively (alum=240 mg/L). This fibrous treatment also provided a total organic carbon (TOC) removal of 54% and a phosphorus removal of 93% (200 mg fibers/L combined to 240 mg alum/L; screened with a 1000 μm mesh size).

As seen therefore, the examples described above and illustrated are intended to be exemplary only. The scope is indicated by the appended claims.

### REFERENCES

Gupta, V. K.; Ali, I.; Saleh, T. A.; Nayak, A.; Agarwal, S. Chemical treatment technologies for waste-water recycling—an overview. Rsc Advances 2012, 2, 6380-6388.
Lapointe, M.; Barbeau, B. Substituting polyacrylamide with an activated starch polymer during ballasted flocculation. Journal of Water Process Engineering 2019, 28, 129-134.
Lapointe, M.; Barbeau, B. Evaluation of activated starch as an alternative to polyacrylamide polymers for drinking water flocculation. Journal of Water Supply: Research and Technology—AQUA 2015, 64, 333-343.
Lapointe, M.; Barbeau, B. Selection of media for the design of ballasted flocculation processes. Water Research 2018, 147, 25-32.
Lapointe, M.; Barbeau, B. Characterization of ballasted flocs in water treatment using microscopy. Water Research 2016, 90, 119-127.
Lapointe, M.; Brosseau, C.; Comeau, Y.; Barbeau, B. Assessing Alternative Media for Ballasted Flocculation. Journal of Environmental Engineering 2017, 143, 04017071.
Pal, S.; Mal, D.; Singh, R. P. Cationic starch: an effective flocculating agent. Carbohydrate Polymers 2005, 59, 417-423.
Sun, H.; Kabb, C. P.; Sims, M. B.; Sumerlin, B. S. Architecture-transformable polymers: Reshaping the future of stimuli-responsive polymers. Progress in Polymer Science 2019, 89, 61-75.
Bolto, B.; Gregory, J. Organic polyelectrolytes in water treatment. Water Research 2007, 41, 2301-2324.
Lapointe, M.; Barbeau, B. Understanding the roles and characterizing the intrinsic properties of synthetic vs. natural polymers to improve clarification through interparticle Bridging: A review. Separation and Purification Technology 2020, 231, 115893.
Flocculants: Technologies and Global Markets, March 2017 2017.
Zou, Y.; Hoekstra, P. M.: Use Of Celluloses In Water Treatment. Google Patents, 2015.
Kawamura, S.: Integrated design and operation of water treatment facilities; 2nd ed.; John Wiley & Sons: New York; Toronto, 2000.
Jang, M.; Shin, E. W.; Park, J. K.; Choi, S. I. Mechanisms of arsenate adsorption by highly-ordered nano-structured silicate media impregnated with metal oxides. Environmental science & technology 2003, 37, 5062-5070.
Oliveira, L. C. A.; Rios, R. V. R. A.; Fabris, J. D.; Sapag, K.; Garg, V. K.; Lago, R. M. Clay-iron oxide magnetic composites for the adsorption of contaminants in water. Applied Clay Science 2003, 22, 169-177.
Lu, X.; Deng, S.; Wang, B.; Huang, J.; Wang, Y.; Yu, G. Adsorption behavior and mechanism of perfluorooctane sulfonate on nanosized inorganic oxides. Journal of Colloid and Interface Science 2016, 474, 199-205.
L\check{ü}, J.; Liu, H.; Liu, R.; Zhao, X.; Sun, L.; Qu, J. Adsorptive removal of phosphate by a nanostructured Fe—Al—Mn trimetal oxide adsorbent. Powder Technology 2013, 233, 146-154.
Zeng, L.; Li, X.; Liu, J. Adsorptive removal of phosphate from aqueous solutions using iron oxide tailings. Water Research 2004, 38, 1318-1326.
Biswal, D. R.; Singh, R. P. Characterisation of carboxymethyl cellulose and polyacrylamide graft copolymer. Carbohydrate Polymers 2004, 57, 379-387.
Mosse, W. K.; Boger, D. V.; Simon, G. P.; Gamier, G. Effect of cationic polyacrylamides on the interactions between cellulose fibers. Langmuir 2012, 28, 3641-3649.
Lapointe, M.; Farner, J.; Hernandez, L. M.; Tufenkji, N. Understanding and Improving Microplastics Removal during Water Treatment: Impact of Coagulation and Flocculation. Environmental Science & Technology 2020.
Lapointe, M.; Barbeau, B. Dual starch-polyacrylamide polymer system for improved flocculation. Water Research 2017, 124, 202-209.
Kosmulski, M. The pH-dependent surface charging and points of zero charge: V. Update. Journal of colloid and interface science 2011, 353, 1-15.
Benjamin, M. M.; Sletten, R. S.; Bailey, R. P.; Bennett, T. Sorption and filtration of metals using iron-oxide-coated sand. Water research 1996, 30, 2609-2620.

1. A method of separating contaminants from contaminated water comprising:
providing a fibrous treatment agent to the contaminated water, wherein the fibrous treatment agent has a length of at least 100 μm and a diameter of at least 5 μm;
allowing the fibrous treatment agent to associate with the contaminants forming flocs comprising a size of at least 1000 μm; and
physically separating the flocs from the contaminated water.

2. The method according to claim 1, wherein the fibrous treatment agent comprises at least one of fibers, microspheres, flakes, hydrogels, and sponge materials.

3. (canceled)

4. The method according to claim 1, wherein the fibrous treatment agent comprises functionalized fibers.

5. The method according to claim 1, wherein the fibrous treatment agent comprises metal-grafted fibers or polymer-grafted fibers.

6. The method according to claim 1, further comprising the step of washing and/or fragmenting the flocs to retrieve and/or reuse the fibrous treatment agent, wherein a portion of the fibrous treatment agent provided includes recovered fibrous treatment agent obtained after the physically separating the flocs from the contaminated water.

7. (canceled)

8. The method according to claim 1, wherein said physically separating includes one or more of sedimentation, decantation, aggregation, coagulation, flocculation, ballasted flocculation, settling, screening, three dimensional screening, three dimensional porous collector, sieving, adsorption, flotation, biological treatment, sludge blanket clarifiers, gravitational separation, press filtration, belt filtration, separation via a fluidized bed, and filtration.

9. The method according to claim 8, wherein the filtration includes at least one of granular filtration, biofiltration, membrane filtration, and biosorption.

10. The method according to claim 8, wherein the gravitational separation includes at least one of ballasted flocculation, flocculation, and flotation.

11. The method according to claim 1, wherein the physical separating includes passing the contaminated water through a sieve, a screen, and/or a rotating drum.

12. The method according to claim 1, wherein the fibrous treatment agent is a bridging agent, a ballasting agent, an adsorbent, a flocculant and/or a coagulation agent.

13. (canceled)

14. The method according to claim 4, wherein the functionalized fibers are functionalized with Si, Fe, Al, Ca, Ti, Zn (hydr)oxides, polymers, coagulants, flocculants, hydrophobic or hydrophilic entities, polar or non-polar groups, a carboxyl group, a sulfonated group, and/or a phosphoryl group.

15. The method according to claim 1, wherein the fibrous treatment agent is iron grafted fibers.

16. The method according to claim 1, wherein the fibrous treatment agent comprises microspheres having a diameter of at least 20 μm.

17. The method according to claim 16, wherein the microspheres are surface functionalized with Si, Fe, Al, Ca, Ti, and Zn (hydr)oxides, polymers, coagulants, flocculants, hydrophobic or hydrophilic entities, polar or non-polar groups, a carboxyl group, a sulfonated group, and/or a phosphoryl group.

18. The method according to claim 1, wherein the fibrous treatment agent comprises flakes having a diameter of at least 20 μm.

19. The method according to claim 18, wherein the flakes are functionalized with Si, Fe, Al, Ca, Ti, Zn (hydr)oxides, polymers, coagulants, flocculants, hydrophobic or hydrophilic entities, polar or non-polar groups, a carboxyl group, a sulfonated group, and/or a phosphoryl group.

20. (canceled)

21. The method according to claim 1, further comprising providing a bridging agent, a ballasting agent, an adsorbent, a coagulant and/or a flocculant to the contaminated water.

22. The method according to claim 21, wherein the coagulant, the adsorbent and/or the flocculant are recovered with the fibrous treatment agent and recirculated and/or reused during aggregation or for separating the contaminants.

23-24. (canceled)

25. The method according to claim 1, wherein the physically separating step is a screening step with a mesh size of at least 100 μm.

26. (canceled)

27. The method according to claim 1, wherein the fibrous treatment agent is iron grafted fibers having an aspect ratio of length over diameter of at least 10.

28-34. (canceled)
